(19) United States
(12) Patent Application Publication
(10) Pub. No.: US 2015/0134380 A1
(43) Pub. Date: May 14, 2015

(54) COMPUTERIZED SYSTEM AND METHOD FOR DETERMINING AN ACTION PERSON'S VALUE TO PARTIES TO A TRANSACTION

(71) Applicant: Adaequare Inc., Chantilly, VA (US)

(72) Inventor: Pavan Peechara, Chantilly, VA (US)

(21) Appl. No.: 14/599,897

(22) Filed: Jan. 19, 2015

Related U.S. Application Data
(63) Continuation of application No. 14/214,391, filed on Mar. 14, 2014.
(60) Provisional application No. 61/786,137, filed on Mar. 14, 2013.

(51) Int. Cl. G06Q 30/02; G06Q 10/06

(52) U.S. Cl. CPC G06Q 30/0282; G06Q 10/063
USPC 705/7.11

(57) ABSTRACT

The present invention is a computerized method to compute scores representing the value of a creator of content to the parties associated with a transaction.

### CROSS-REFERENCES TO RELATED APPLICATIONS

This application is a continuation of patent application Ser. No. 14/214,391, which claims priority to provisional application 61/786,137, filed on Mar. 14, 2013. All of the above applications are herein incorporated by reference in their entirety as if fully recited herein.

### FIELD OF THE INVENTION

The present invention relates generally to computerized systems and methods for calculating the relationships between interactions on the Internet and certain business transactions and the influence exerted on parties to such transactions.

### BACKGROUND AND SUMMARY OF THE INVENTION

Parties thinking of engaging in transactions increasingly turn to the Internet to obtain information to help them make decisions with regard to the transaction. As a result, those parties seeking to market products and services have an increasing need to understand the influence that information available on the Internet asserts on the transaction in order to make decisions with regard to how to promote their products or services. Users of the Internet who exchange views, opinions, information, or exchange any form of content may be generating influencing actions (referred to herein as action entities) that have an implicit value towards one or more transactions. Examples of such action entities may comprise product or service reviews, comments about the product or service that may be found in online communications, endorsements, comments about ownership, product or service “likes” on various forms of social media, or other such actions which may directly or indirectly influence a transaction. Action entities may be related to transactions such as project and business investments, product and services purchases, and funding activities. Action entities may be contributed by individual people, organizations, or businesses. The action entities may help the parties considering a transaction make their decisions with regard to whether to participate in a transaction, when to participate, or who may be the other transaction person. An example transaction may be the purchase of a new car. A potential purchaser may read reviews and comments to decide which model of car to buy and when to buy it. That same purchaser may read comments from social media and other sources to help them learn which dealership or even salesperson has the best reputation to assist their decision regarding where to actually purchase the vehicle.

There are many organized avenues and channels for marketing products, services, projects or businesses. Included in these channels are the Internet, print media, trade shows, and interaction with others on the streets. There are direct and indirect costs involved in participating in these avenues and channels; many require payment to promote products and services or otherwise participate irrespective of the actual return on such payments. For this reason, individuals and businesses may turn to options that are less expensive or free. Until recently, these individuals and businesses often were limited to family members or friends to provide word of mouth promotion. Although these word of mouth options are still available, individuals and businesses without substantial financial resources may be constrained by the financial cost involved in attempting to influence a purchaser or investor using traditional advertising methods.

With the advent of Internet technology and its increasing use as a means for social interaction and easy publication of information, there is an opportunity to better utilize the information generated by and gathered from social media and marketing interactions to contribute towards business generation. Despite the low cost, participating in social media may consume resources that could be used for other purposes resulting in an opportunity cost. There currently is a need for effective methods and systems to assist with the determination of how to utilize these resources by rating and ranking the influence such social media and marketing interactions have on transactions between parties with access to the social media and marketing interactions. Prior to the disclosed invention, those hoping to promote their projects, products or services were unable to efficiently evaluate the effectiveness of their direct efforts at promotion or the good will that they earn from successful interactions with others. Such a need may be satisfied with a computerized system and method that calculates the influence of those performing interactions that may influence the transaction.

Interactions that take place on the Internet may be more formal types of interactions comprising interactions such as offering product or service reviews, celebrity endorsements, existing user or customer ratings, and articles written on news and information web sites. Other types of interactions may be less formal and might comprise such actions as “liking” a product, manufacturer, service, or service provider on a social media site, “pinning” a product on a site such as Pinterest® (www.pinterest.com), or sharing a product reference on a social media site with friends and acquaintances.

The influence that an interaction may have on a transaction may be related to the relationship between the action person involved in the interaction and the person performing the transaction. The influence may also be related to the action person's knowledge of and connection to the subject matter of the transaction or the action person's scope of influence on the public at large.

A relationship factor corresponding to an action person's relationship with a transaction person may be derived by considering the connection between the two parties with regard to common friends and acquaintances, the amount of collaboration between the parties in the past, their past exchange of action entities, and the past exchange of action entities between the parties that are related to the transaction being evaluated. In order to compute an influence factor, the action person's relationship between the person who is part of the transaction may be factored with the action person's reputation within the population of which the transaction person is a part and the perception that an action person is knowledgeable in the subject area of the transaction. The relationship between the action person and the transaction person may be calculated by combining factors representing friendship, past collaboration, social connections, and a correlation between the transaction, the action person, and the transaction person.

The relevance that an interaction may have to a transaction may be related to both the type of transaction and the type of interaction. For example, for a purchase that involves a higher cost, the purchaser might be more relevant to a product review or article and not put as much weight on a comment from a friend that he or she likes the product. Alternatively, a shared product reference of a friend on a social media site may be more relevant to a purchase of something relatively inexpensive or non-complex. In order to reduce confusion related to the similarity in the concepts of interaction and transaction, an interaction may be referred to herein as an action entity. This term reflects that the interaction is an action taken by an action person and the concept that these interactions (action entities) are a key component in the calculation of the relevance an interaction may have on a future transaction.

Relevance factor represents the relevance that an action entity may have with regard to a transaction. In order to compute a relevance factor, characteristics of the action entity that are common to a transaction may be considered and factored into an interim relevance factor. One such factor may be the time period between the action entity and the transaction. This factor may reflect the greater relevance that a more recent action entity may have to a transaction. Another such factor may be the similarity in content between an action entity and the characteristics of the transaction. The context of the action entity content may also be compared to that of the transaction to derive a context relevance factor. Together time, content, and context relevance are combined to produce an interim relevance factor that represents the relevance of an action entity to a transaction.

Because of the increasingly large number of interactions resulting in action entities that take place, a minimum relevance factor threshold may be applied to the interim relevance factor to limit the number of action entities that are considered when calculating a relevance factor. Such limitation may prevent a large number of action entities with very low interim relevance factors from skewing the resulting relevance factor calculations. An action entity type factor may compensate for the varying amounts of impact that an action entity may have depending on the type of action and transaction.

An action entity type factor may be applied to the limited interim relevance factors. These two variables may produce a relevance factor for each action entity type that is representative of the relevance of action entities on a transaction. The resulting relevance factor may be used to aid in decision making with regard to marketing efforts with regard to a target transaction type.

The impact of an action person's action entity on a transaction may be represented by an impact factor that combines both the relevance between an action entity and the transaction and the influence that the action person exerts on the transaction person. The impact factor may be calculated by combining the relevance factors and influence factors previously described. The impact factor may be employed to provide a much needed understanding of influences exerted by information available on the Internet on the user's product or service.

The transaction worthiness of an action entity represents the impacts the action entity has had over different transactions in the past. An action entity's transaction worthiness value may be computed by considering each impact value the action entity received from the different transactions in the past.

The calculated impact factor for an action entity with regard to a transaction and an action entity's transaction worthiness for prior transactions may be combined to derive an importance value for an action entity and as a result, for the action person of that action entity. Such an importance value may be used by a user of the invention to determine the value that the action person may represent with regard to the promotion of the user's product or service that may become the subject of a transaction. The user may then make decisions regarding how best to invest their promotion budget in an attempt to make connections with action persons much like the user may have had to decide how best to encourage word of mouth promotion prior to the Internet.

An action person's transaction worthiness, reach, expert and star factors represent the action person's reputation within the population of which the transaction person is a part and the perception that an action person is knowledgeable in the subject area of the transaction. An action person's transaction worthiness value represents the computation that considers each action entity's transaction worthiness that was created by the action person in the past. An action person's reach represents the distinct accesses of each action entity created by an action person. The transaction worthiness value and the reach value may be further refined by filtering the input factors used in their calculation to represent certain transaction types, time periods, geographic areas, or characteristics of the transaction person (demographic filtering).

The Star Factor of the action person within the population of which the transaction person is a part of may be calculated by combining input values representing an action person's transaction worthiness and reach. The Expert Factor of an action person with respect to a transaction or transaction type within the population of which a transaction person is a part of may be calculated by combining factors representing the action person's transaction worthiness for a selected transaction classification and reach.

### BRIEF DESCRIPTION OF THE DRAWINGS

In addition to the novel features and advantages mentioned above, other benefits will be readily apparent from the following descriptions of the drawings and exemplary embodiments:

FIG. 1 is a block diagram of an exemplary computer device which may be configured to perform an exemplary embodiment of the invention;

FIG. 2 is a symbolic representation of an embodiment of the invention showing the relationship between those factors which are used to derive a relevance factor;

FIG. 3 is a flow chart of an embodiment of the invention illustrating the calculations and factors which are used to derive a time relevance factor;

FIG. 4 is a flow chart of an embodiment of the invention illustrating the calculations and factors which are used to derive a content relevance factor;

FIG. 5 is a flow chart of an embodiment of the invention illustrating the calculations and factors which are used to derive a context relevance factor;

FIG. 6 is a flow chart of an embodiment of the invention illustrating the calculations and factors which are used to derive an interim relevance factor;

FIG. 7 is a flow chart of an embodiment of the invention illustrating the calculations and factors which are used to derive a relevance factor;

FIG. 8 is a symbolic representation of an embodiment of the invention showing the relationship between various factors used to derive an influence factor;

FIG. 9 is a flow chart of an embodiment of the invention illustrating the calculations and factors which are used to derive a friendship factor;

FIG. 10 is a flow chart of an embodiment of the invention illustrating the calculations and factors which are used to derive a transaction correlation factor;

FIG. 11 is a flow chart of an embodiment of the invention illustrating the calculations and factors which are used to derive a collaboration factor;

FIG. 12 is a flow chart of an embodiment of the invention illustrating the calculations and factors which are used to derive connection factor;

FIG. 13 is a flow chart of an embodiment of the invention illustrating the calculations and factors which are used to derive a relationship factor;

FIG. 14 is a flow chart of an embodiment of the invention illustrating the calculations and factors which are used to derive an influence factor;

FIG. 15 is a symbolic representation of an embodiment of the invention showing the relationship between various factors used to derive an impact factor;

FIG. 16 is a flow chart of an embodiment of the invention illustrating the calculations and factors which are used to derive an impact factor;

FIG. 17 is a symbolic representation of an embodiment of the invention showing the relationship between various factors used to derive transaction worthiness;

FIG. 18 is a flow chart of an embodiment of the invention illustrating the calculations and factors which are used to derive transaction worthiness of an action entity;

FIG. 19 is a flow chart of an embodiment of the invention illustrating the calculations and factors which are used to derive an importance factor;

FIG. 20 is a symbolic representation of an embodiment of the invention showing the relationship between various factors used to derive an importance factor;

FIG. 21 is a flow chart of an embodiment of the invention illustrating the calculations and factors which are used to derive an importance factor;

FIG. 22 is a flow chart of an embodiment of the invention illustrating the calculations and factors which are used to derive a time factor;

FIG. 23 is a flow chart of an embodiment of the invention illustrating the calculations and factors which are used to derive action type minimum relevance factor;

FIG. 24 is a flow chart of an embodiment of the invention showing the calculations and factors which are used to derive an action type weight;

FIG. 25 is a flow chart of an embodiment of the invention illustrating the calculations and factors which are used to derive reach factor;

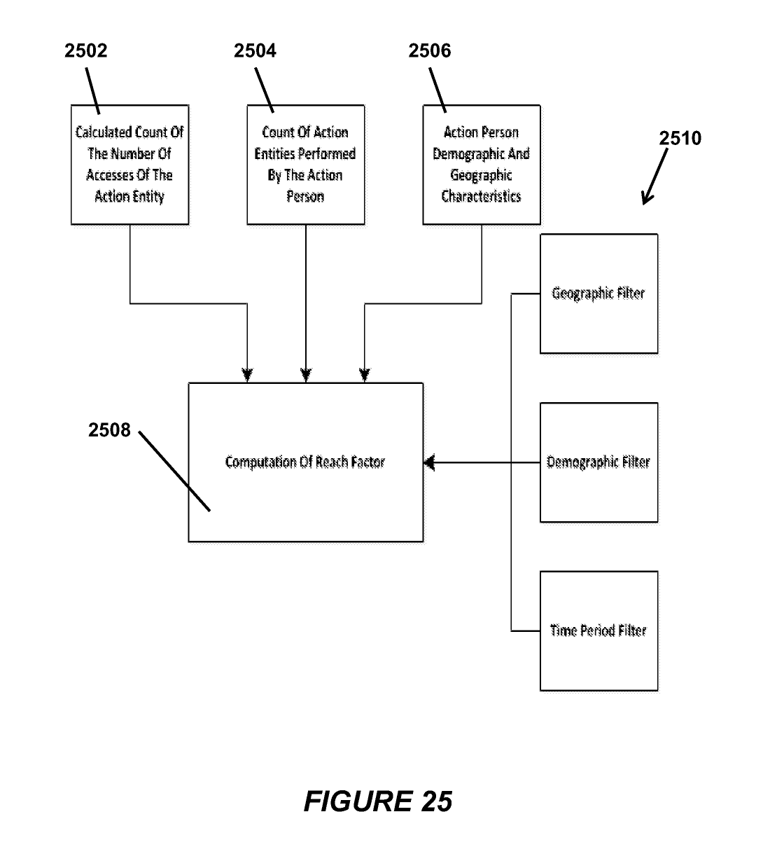

FIG. 26 is a symbolic representation of an embodiment of the invention showing the calculations and factors which are used to derive star and expert factors;

FIG. 27 is a flow chart of an embodiment of the invention illustrating calculations and factors which are used to derive a star factor; and

FIG. 28 is a flow chart of an embodiment of the invention illustrating calculations and factors which are used to derive an expert factor.

### DETAILED DESCRIPTION OF THE INVENTION

The disclosed methods may be implemented as computer-executable instructions. Such instructions may be stored on one or more computer-readable storage media and executed on a computer (e.g., any commercially available computer, including smart phones or other mobile devices that include computing hardware). The computer-executable instructions for implementing the disclosed techniques as well as any data created and used during implementation of the disclosed embodiments may be stored in one or more computer-readable media (e.g., non-transitory computer-readable media). The computer executable instructions can be part of, for example, a dedicated software application or a software application that is accessed or downloaded via a web browser or other software application (such as a remote computing application). Such software may be executed on a single local computer (e.g., any suitable commercially available computer) or in a network environment (e.g., via the Internet, a wide-area network, a local-area network, a client-server network (such as a cloud computing network), or other such network) using one or more network computers.

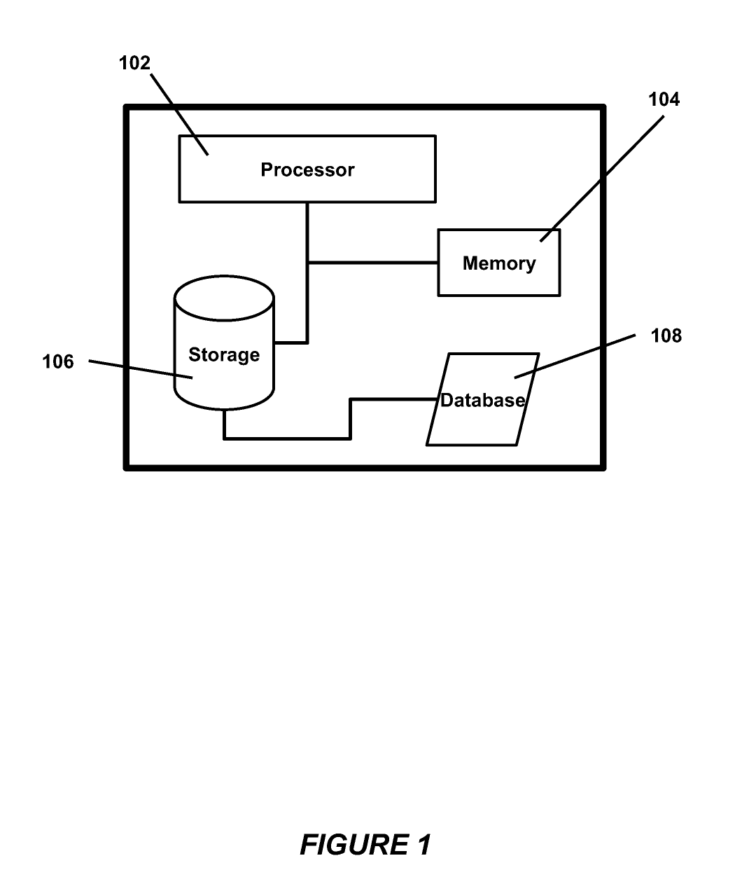

Referring to FIG. 1, an exemplary embodiment of a computerized device may comprise a processor 102, a memory 104, and a storage device 106, where that storage device may contain a database 108 which further contains data which represents transaction, action entity, action person and transaction person information. The illustrated computerized device may be in electronic communication with other computerized devices and databases not shown in FIG. 1. In such a computerized device, the processor 102 may execute software instructions to retrieve and transmit data as well as to calculate the various factors, scores, and values described herein.

Although the operations of some of the disclosed methods are described in a particular, sequential order for convenient presentation, it should be understood that this manner of description encompasses rearrangement, unless a particular ordering is required by specific language set forth herein. For example, operations described sequentially may, in some cases, be rearranged or performed concurrently. Moreover, for sake of simplicity, the attached figures may not show the various ways in which the disclosed methods can be used in conjunction with other methods.

As used herein, an interaction may be an occurrence on the Internet in which an action person makes a direct or indirect reference to a product, service, business opportunity, or other transaction. Examples of such interactions may be, but are not limited to, recommendations; reviews; ratings; references to ownership; posting or liking a text, image or video content; and other comments related to the subject of a transaction. Interactions may be any digital content such as textual, image or video. Action entities may also be re-distributing the content of others such as the sharing of another's textual, image or video content. An interaction may also be referred to herein as an action entity to reflect that the interaction may be a discrete action performed by an action person.

As used herein, action person refers to a party performing an action entity.

As used herein, a transaction may be, but is not limited to, a purchase, exchange, or other participation in an exchange of money, goods or services between two or more parties.

As used herein, transaction information refers to, but is not limited to, information about the subject of the transaction, information that may be produced to inform potential participants of the transaction, information about the participants to the transaction, meta information, and a classification that may be assigned to the transaction as described herein.

As used herein, action entity information refers to, but is not limited to, information about the action entity such as its source, the content of the action entity, a classification type that may be assigned, the type of action entity, and meta information that may be generated as the result of the transaction.

As used herein, a first content may refer to content such as that content found in an action entity.

As used herein, a second content may refer to content such as that found in an transaction.

As used herein, transaction person refers to a party that is directly involved in a transaction that may be influenced, impacted, or otherwise effected by an action entity. The factors described herein generally relate to a relationship or connection between one or more action persons and a transaction person.

An embodiment of the invention may use system assigned or predetermined factors such as transaction type, time factor, minimum relevance factor, and action type weight.

A time factor may be used to limit action entity data considered during the calculation of an action entity's relevance to a transaction. Time factor calculations take into account transaction type and may also consider the creation date or time of an action entity, the date or time of access of the action entity by the transaction person prior to the respective transaction. The time factor should not be confused with time relevance factor described herein which may be used to determine the relevance of an action entity to a transaction based on a combination of parameters such as time between action entity creation or action entity access by transaction person and the transaction occurrence.

Transaction types may be used to classify and group the data considered based on groups of similar transaction types. Time factor and minimum relevance factor may be used to limit the data processed based on minimum qualification criterion. Such minimum qualification criterion is determined for each transaction classification and as a result, time factor and minimum relevance factor may vary based on the transaction classification being analyzed.

Action type weight is to normalize the effective influence that certain action entity types have over the others based on transaction types. The invention may use a variety of data points representing transactions, user interactions, derived calculations, and such other information that were performed over a predetermined period of time in the past.

Embodiments of the invention may use a variety of information that have been calculated or measured in the past. Such information may comprise transaction information, transaction person information, and user interaction information. The information may also comprise various computations performed by the system to further determine each action person's influence over people or entities such as reach factor, transaction worthiness factor, star factor, and expert factor. These factors may be filtered by applying similarity criteria such as transaction classification, geographic parameters, demographic parameters, and time periods. Such values may be used to calculate the action entity's influence on a transaction.

Transaction worthiness refers to a cumulative impact of an action or person on a transaction. Transaction worthiness may be used to establish a value of an action or person with regard to a transaction or transaction category. Transaction worthiness may be expressed as action entity transaction worthiness, which refers to an action entity's cumulative impact on transactions to which the action entity is found to be relevant. Transaction worthiness may also be expressed as action person transaction worthiness, which is an action entity's cumulative action entity transaction worthiness of the action person on various transactions. Action entity transaction worthiness may also be normalized when calculated according to relevant action entity to produce an action entity transaction worthiness factor.

As will be described in more detail below, transactions may be grouped into categories based on their characteristics. Categories may be defined using such established categorization standards as the North American Industry Classification System (NAICS), developed by the U.S. Department of Commerce, or defined according to categories more suited to the transaction types and action entities being analyzed in a particular embodiment or application of the invention.

A minimum relevance factor may also be used to limit transaction or action entity data considered for calculation of an action entity's relevance to that of a transaction based on the transaction classification. Such a factor should not be confused with relevance factor described herein or even with the interim relevance described herein which may be used to determine the relevance of an action entity to a transaction based on a combination of factors such as time relevance, content relevance and context relevance.

### Relevance Factor

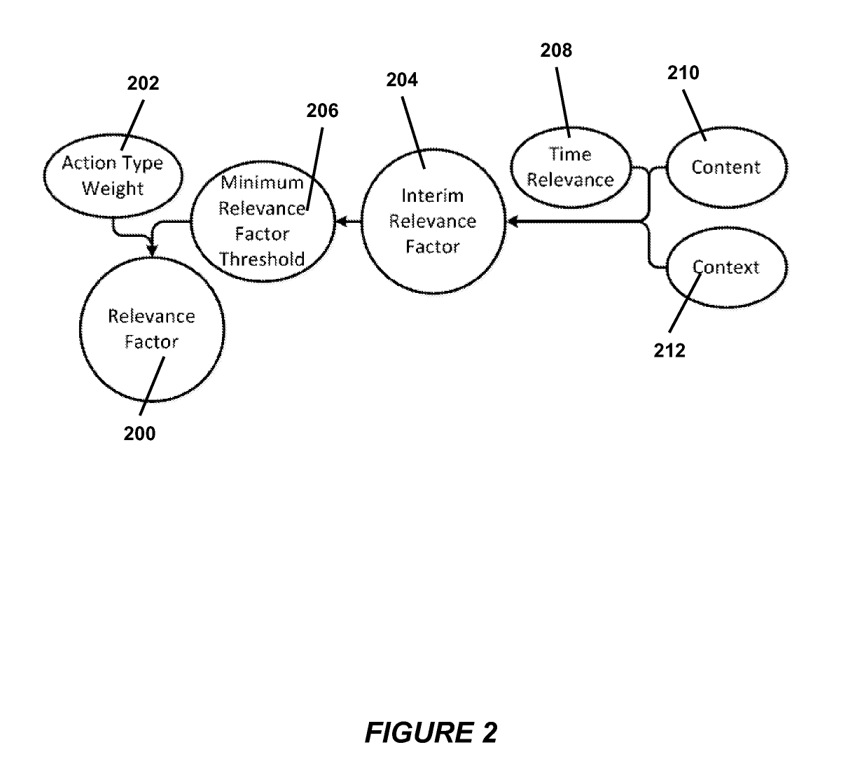

A relevance factor representative of the relationship between an interaction which takes place on the Internet and a transaction may be calculated using a computerized device. When calculating relevance factor, examples of the invention may use the steps and formula described herein. In other embodiments of the invention, some or all of the steps and formula described herein may be used. Still other embodiments may use alternate steps, equations, inputs, and values without departing from the spirit of the invention. In an embodiment of the invention, a processor 102 may perform software steps to calculate a relevance factor. FIG. 2 represents a graphic diagram of the various factors which may comprise the relevance factor in an embodiment of the invention. As is illustrated, a relevance factor 200 may be calculated from additional factors calculated by the processor or obtained from prior calculations. Such additional factors may comprise an action entity type factor 202 and an interim relevance factor 204 to which a minimum relevance factor threshold 206 has been applied. The minimum relevance factor threshold 206 is a predetermined factor used by an embodiment of the invention to limit the action entities used to calculate relevance factor to those above a minimum relevance value to limit the effect of a potentially large number of action entities with a very low calculated interim relevance value. As is illustrated in FIG. 2, the interim relevance factor 204 may be calculated using time relevance 208, content relevance 210, and context relevance factors 212. Each factor used to calculate the relevance factor will now be described in detail starting with the factors which are used to calculate the interim relevance factor 204.

The relevance of an action entity accessed by a transaction person for the respective transaction performed may consider all the available action entities the transaction person has accessed prior to committing the particular transaction. Such action entities accessed may be subject to a time factor which serves to limit the number of action entities to be considered for further calculations. Time factor is a pre-determined system value for each transaction classification. Thus the action entities accessed by the transaction person ahead of committing the transaction that have passed the time factor limiting criterion are processed for time relevance, content relevance, context relevance and thus may be considered in further calculations.

### Time Relevance

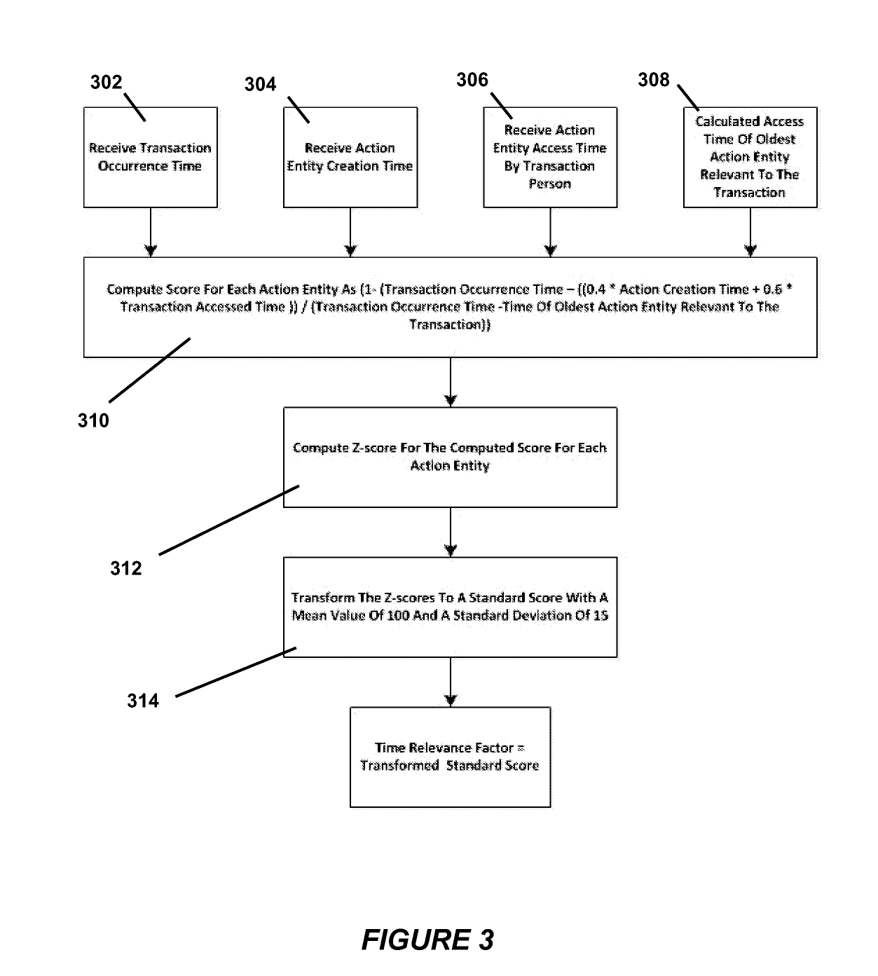

Time relevance is the representation of the time at which an action entity took place with respect to the transaction. Time relevance also takes into account the time that other action entities may have taken place with respect to the action entity being evaluated. For instance, the time relevance of the action entity being evaluated may be lower if another action entity were to take place much closer to the time of the transaction than the action entity being evaluated. Conversely, if the action entity being evaluated were closer in time to the transaction than other action entities, the time relevance of the evaluated action entity may be greater. When calculating time relevance, examples of the invention may use the steps and formula described herein. In other embodiments of the invention, some or all of the steps and formula described herein may be used. Still other embodiments may use alternate steps, equations, inputs, and values without departing from the spirit of the invention. Referring to FIG. 2, a time relevance factor 208 may determine the degree of time relevance of an action entity to the transaction with respect to the transaction classification. The time relevance factor of an action entity may be calculated based on the time at which the action entity took place with respect to the transaction. In addition, the time relevance factor considers the time at which the transaction person was exposed to the action entity. For example, if the action entity were a product review published on a web site, the time relevance factor may consider the time at which the transaction person accessed the review on the web site. Referring to the flow chart of FIG. 3 in an embodiment of the invention, a processor 102 may execute software instructions to receive time based information comprising a transaction occurrence time 302, action entity creation time 304, action entity access time 306, and access time of the oldest action entity relevant to the transaction 308. In step 310, the processor may execute software instructions to compute a time relevance score using Equation 1, where Tₜ may be a transaction occurrence time, T_{c} may be the action entity creation time, Tₐ may be the action entity accessed time by the transaction person of the transaction for which the time relevance factor is being computed, and Tₒ may be the accessed time of the oldest action entity from a set of action entities relevant to the transaction for which the time relevance factor is being computed. Embodiments of the invention may compute time relevance for each action entity associated with the transaction. The resultant factors may be combined with other factors and then subject to a relevance threshold using software instructions executed by a processor 102. Factors above the threshold may be considered qualified factors.

Time Relevance Score=1<((Tₜ−(0.4*T_{c}+0.6*Tₐ))/(Tₜ−Tₒ)) Equation 1

In an exemplary embodiment, time relevance scores may be calculated using a processor 102 for each action entity from the set of action entities relevant to the transaction. In step 312 z-scores may then be computed for the time relevance scores calculated by Equation 1. In step 314 these computed z-scores may then be transformed to standard score with mean value of 100 and a standard deviation of 15. The transformed score for the action entity being evaluated for time relevance is the time relevance factor 208 of the action entity to the transaction for which the time relevance factor is being computed.

### Content Relevance

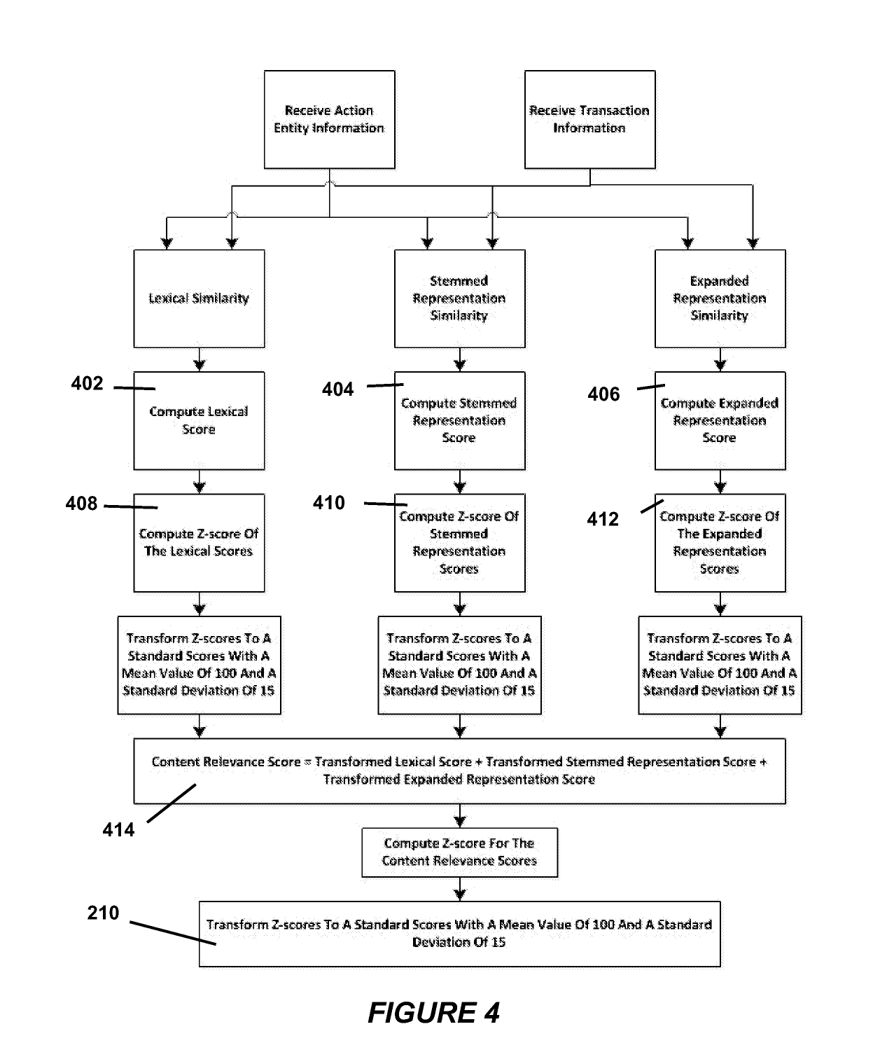

Content relevance represents the relevance of the words within and the meta-information associated with the action entities to the content of the transaction information for the transaction being analyzed. Transaction information may include, but is not limited to, such information as information about the transaction party, information about the transaction item, and transaction classification. Content relevance calculation between any two different content objects may be computed using standard methods of calculating the content relevance of two or more content objects. Embodiments of this invention may uniquely adopt such standard methods to compute content relevance of a content object considered as an action entity in this invention to that of the transaction information that may comprise transaction classification and transaction party detail. When calculating content relevance, examples of the invention may use the steps and formula described herein. In other embodiments of the invention, some or all of the steps and formula described herein may be used. Still other embodiments may use alternate steps, equations, inputs, and values without departing from the spirit of the invention. One such method for content relevance computation is illustrated in FIG. 4. In an embodiment of the invention, a processor 102 may execute software instructions to perform the illustrated calculations. As is illustrated in FIG. 4, a content relevance factor 210 is comprised of lexical similarity scores 402, stemmed representation similarity scores 404, and expanded representation scores 406. Using these three scores, content relevance factor is calculated for every action entity that is found to be accessed by the transaction person prior to the transaction and ahead of the time factor for the said transaction's transaction classification. The qualification process may be the same as described in the discussion of time relevance factor herein. To compute the content similarity between an action entity and the transaction, a method may be used which combines the ranking of various text similarity measures. One such similarity measure is a lexical similarity measure. This measure matches the terms present in the text (surface representation) using criteria such as exact lexical match, phrase match (phrase lexical measure) and subset measure (subset lexical measure). In an embodiment of the invention, expanded text representation methods may also be used. Such methods enrich the text in the analyzed action entities and transactions using external information sources to provide additional contextual text. This additional contextual test is used to expand the text of the action entities and transaction prior to measurement of matching terms. Dense probability matching methods use an expended query representation for the compared texts. This method also ranks the matches using the negative Kullback-Leibler divergence method (a non-symmetric measure of the difference between two probability distributions). An embodiment of the invention may rank exact matches, exact stems matches, and then dense probability matches. As is illustrated in FIG. 4 at 408, 410, and 412, the scores obtained by the above methods are standardized using the z-score and then transformed to a standard score with a mean of 100 and a standard deviation of 15. At 414, each of these scores are summed to obtain an individual content relevance score for each action entity. The summed score is standardized using the z-score calculation and then transformed to have a mean of 100 and standard deviation of 15. The resultant transformed score is the content relevance factor 210.

### Context Relevance

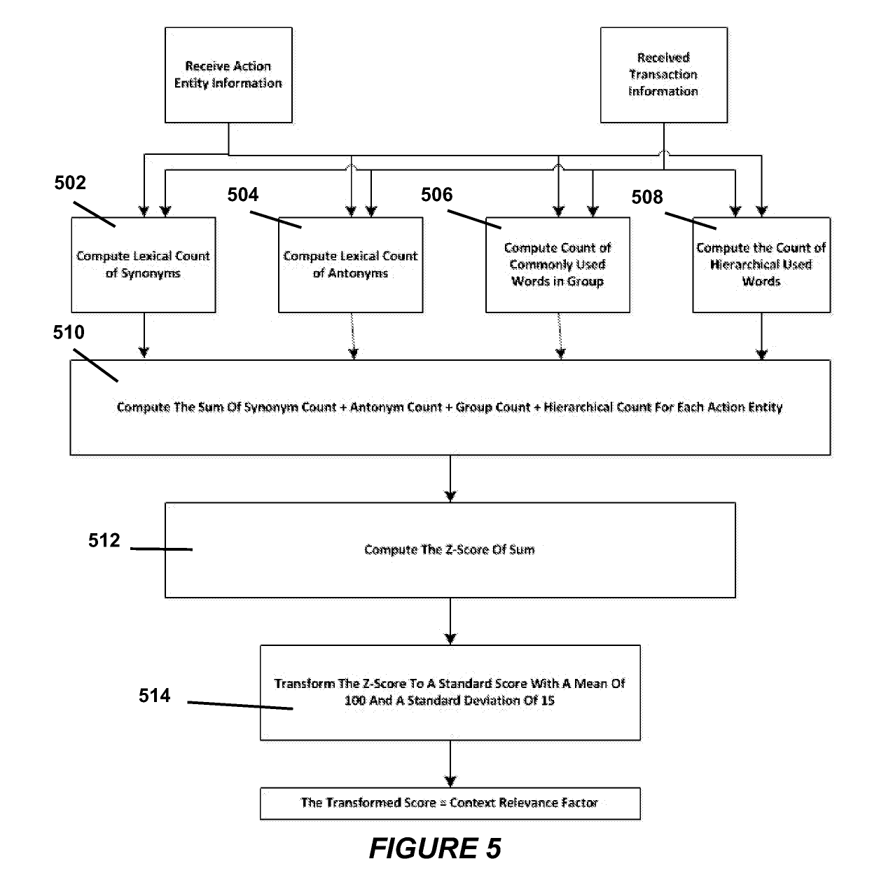

Context relevance represents the contextual relevance of the words within and the meta information associated with the action entities to the content of the transaction information for the transaction being analyzed. The transaction information may include, but is not limited to, such data as information about the transaction party, information about the transaction item, and transaction classification. In the case of a transaction involving a product, the product description and product classification along with the transaction party details may be used as the transaction information. Context relevance calculation between any two different content objects may be computed using standard methods of calculating contextual relevance between two or more content objects. Embodiments of this invention may uniquely adopt such standard methods to compute the context relevance of a content object considered as an action entity in this invention to that of the transaction information. Context relevancy may be used to determine the degree of contextual relevance between an action entity and a transaction with respect to the transaction classification. Context relevancy may be calculated for every action entity accessed by a transaction person prior to the transaction and ahead of the time factor for the said transaction's transaction classification. The qualification process may be the same as described in the discussion of time relevance factor herein. When calculating context relevance, examples of the invention may use the steps and formula described herein. In other embodiments of the invention, some or all of the steps and formula described herein may be used. Still other embodiments may use alternate steps, equations, inputs, and values without departing from the spirit of the invention. In an embodiment of the invention, a processor 102 may execute software instructions to perform the steps illustrated in FIG. 5. As illustrated in FIG. 5, representing such an embodiment of the invention, a lexical count of synonyms 502 is summed with a lexical count of antonyms 504, a computed count of words common to both the action entity and the transaction 506, and a count of hierarchical words used in both the action entity and the transaction 508. The lexical count of synonyms and antonyms may be calculated using WordNet® (Cognitive Science Laboratory, Princeton University). Words used commonly in both action entity and transaction and hierarchical word usage may be calculated using both WordNet® and a data dictionary which may be created by combining generally available dictionaries (Cambridge Free English Dictionary, Cambridge University Press) with dictionaries created over time by embodiments of the invention which comprise transaction classification information, product data from transactions, product metadata, product seller's information, and product manufacturer's information. The sum of the count of synonyms 502, the count of antonyms 504, the count of words common to both action entity and transaction 506, and the count of hierarchical words used in both the action entity and transaction 508 is calculated for every qualified action entity 510. In an embodiment of the invention, a z-score is computed for each calculated sum 512 and the resultant z-scores are then transformed into a standard score with a mean of 100 and a standard deviation of 15 514. The resulting transformed scores are the context relevance scores 212.

### Interim Relevance

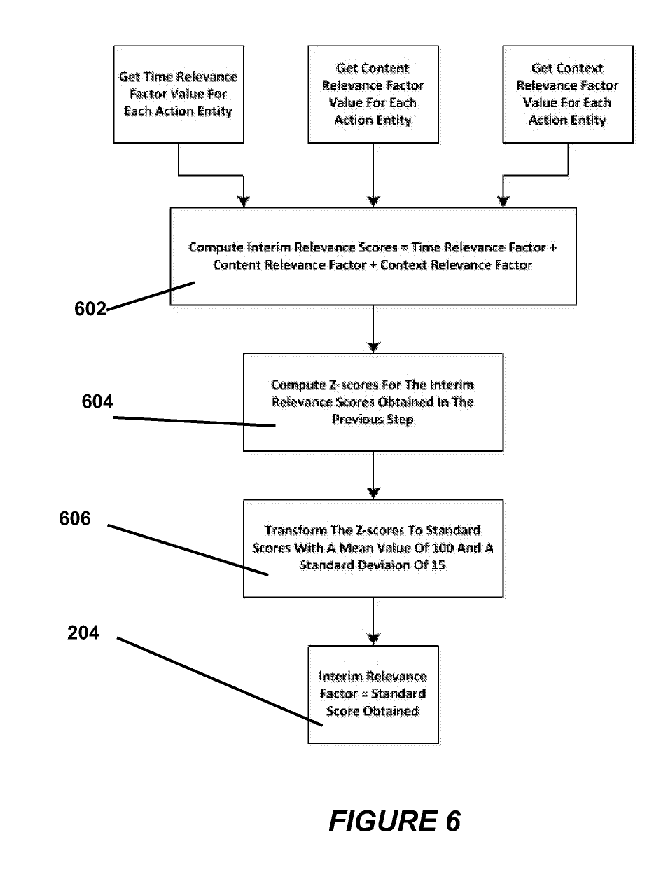

In some embodiments of the invention, an interim relevance factor may be calculated and subject to a minimum relevance value. Referring again to FIG. 2, an interim relevance factor 204 is calculated by combining the time relevance factor 208, the content relevance factor 210, and the context relevance factor 212 for each qualified action entity. When calculating interim relevance, examples of the invention may use the steps and formula described herein. In other embodiments of the invention, some or all of the steps and formula described herein may be used. Still other embodiments may use alternate steps, equations, inputs, and values without departing from the spirit of the invention. Referring to FIG. 6, in an exemplary embodiment of the invention, a processor may execute software instructions to content relevance factor, and context relevance factor to obtain an interim relevancy score for each action entity 602. In some embodiments of the invention, a time relevance factor may also be combined with the content factor and context factor. Z-scores may computed for the interim relevancy scores 604 and then transformed into standard scores with a mean of 100 and a standard deviation of 15 606. These transformed scores are the interim relevance factors 204 for the respective action entities. This interim relevance factor may be subjected to a minimum relevance factor threshold described herein.

Action entities that are accessed by the transaction person prior to committing the respective transaction that are limited by time factor may have interim relevance factors calculated. The system may further limit the action entities for subsequent calculations such as relevance, influence, impact and importance among other such calculations using a minimum relevance threshold value referred to herein as minimum relevance factor. In embodiments of the invention, minimum relevance factor may be a system calculated threshold value for each action entity type with respect to each transaction classification using the various relevance calculation data from the past. The detail of such computation is explained herein. In such an embodiment, the action entities with interim relevance factor values greater than the minimum relevance factor for the respective transaction's transaction classification are qualified for further computations. Such action entities that have an interim relevance factor equal or more than a minimum relevance factor are referred to herein as relevant action entities.

Referring again to FIG. 2, once the interim relevance factor is calculated, action entities with interim relevance factors greater than the calculated minimum relevance factor for their respective action type may be considered as relevant action entities and factored with an action entity type factor 202 to arrive at a relevance factor 200. In certain embodiments of the invention, those action entities with an interim relevance factor values less than the calculated minimum relevance factor may be ignored.

### Action Entity Type Weight Factor

In certain embodiments of the invention, an action type weight factor may be used for normalization of various action entity types for a said transaction classification. This action entity type weight factor compensates for a greater or lesser relevance that a particular action type of action entity may have towards a particular transaction type. As an example, a large number of tweets that occur may be action entity items that are relevant to a transaction such as the purchase of an automobile. The timing, content, and context of those tweets could result in a high interim relevance factor. Conversely, there may be a smaller number of reviews written that pertain to the automobile that a potential purchaser is considering. These reviews may have similar content and context factors to that of the tweets but because of the timing of automobile reviews, which frequently are published at the beginning of the model year, a review may have a lower calculated time relevance factor than that of a tweet. In this example, it is very likely that a review may have more relevance to the purchase of an automobile than a tweet. This may particularly be the case for transactions that involve significant cost or risk to a participant. Because of this, a factor is needed that serves to account for the different amounts of relevance that various type of action entities may have towards a transaction. The action type weight factor may serve this purpose by accounting for the varying levels of relevance that different action entity types may have on a variety of transaction types. The action type weight factor may be a calculation based on factors comprising action entity content relevance factors and context relevance factors for transactions with respect to each transaction classification. Such an action type weight factor may be generated for each transaction classification or for any set of transaction similarity parameters, geographic parameters or demographic parameters based on data generated within the system for the past transactions. Action type weight factors are system generated values for each system assigned or determined action types with respect to the system assigned or determined transaction classifications. The action type weight factor computations are described herein.

### Relevance Factor

A relevance factor may be calculated for every qualified action entity. This calculated relevance factor may be used to determine the degree of relevance of an action entity to the transaction with respect to transaction classification type. The relevance factor may be calculated using an action entity's interim relevance factor and action type weight for the respective transaction classification type. When calculating relevance factor, examples of the invention may use the steps and formula described herein. In other embodiments of the invention, some or all of the steps and formula described herein may be used. Still other embodiments may use alternate steps, equations, inputs, and values without departing from the spirit of the invention.

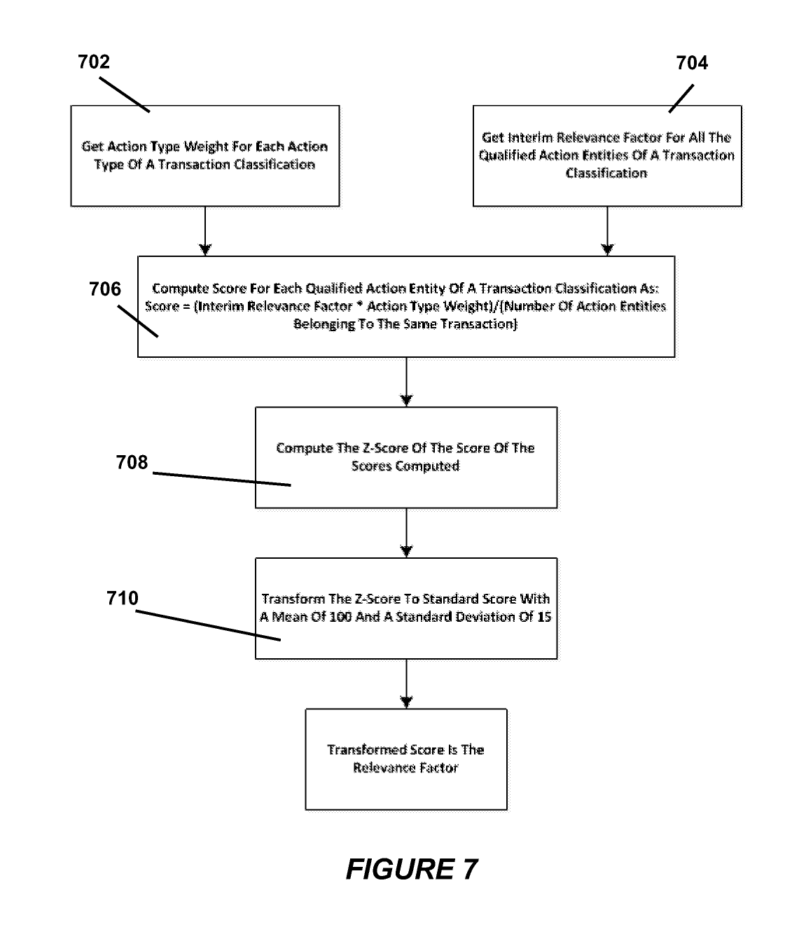

Referring again to FIG. 2, relevance factor 200 calculated for an action entity with respect to a transaction takes into account time content relevance factor 210 and context relevance factor 212. Relevance factor 200 may also take into account relevance factor 208 and/or action entity type weight 202. FIG. 7 illustrates the calculation of relevance factor used in an embodiment of the invention. In such an embodiment, the calculation may be performed by a processor executing software instructions to perform the steps and calculations described herein. In an embodiment of the invention, action entity type weights may be gathered for each action entity type for a transaction classification type 702. Interim relevance factors may be gathered for the same transaction classification type 704. The result is a list of action entity type weights and interim relevance factors for action entities for a given transaction classification type. A relevance score may be calculated for each action entity of a transaction classification type by multiplying interim relevance factors by the corresponding action entity type weight and dividing the result by the number of action entities associated with a transaction 706. This is represented in Equation 2, where R_{f}(A, T) may represent the relevance score of an action entity “A” of the said transaction “T.” T_{irf}(A,T) may represent an interim time relevance factor of an action entity of the said transaction “T.” The variable A_{tw}(A,T) may represent the action type weight of an action entity type for the said transaction “T”, and N_{AE} may represent the total number of action entities of an action entity type that appear in the transaction classification type.

Relevance score (R_{f}(A·T)=T_{irf}(A,T)*A_{tw}(A,T)/N_{AE} Equation 2

The result of performing Equation 2 for action types and action entities associated with each transaction type may be a list of computed relevance scores corresponding to action entities of the given transaction classification type. A z-score may be computed for each computed score 708 and those z-scores transformed to standard scores with a mean of 100 and a standard deviation of 15 710. The resultant transformed scores represent the relevance factor for the action entity corresponding to the score.

### Influence Factor

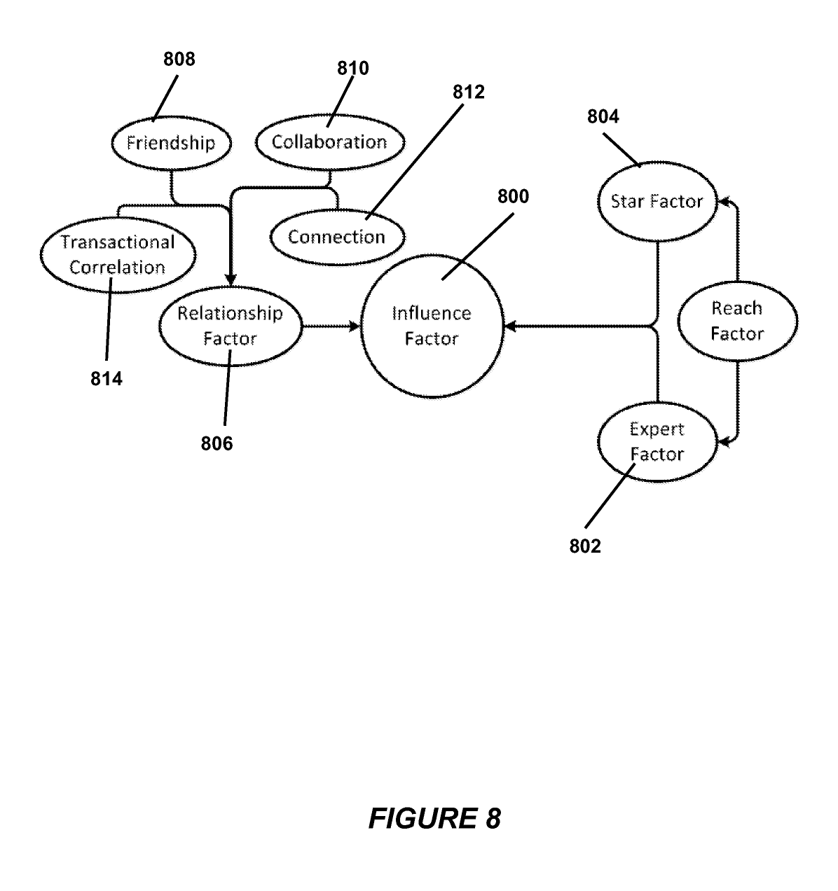

Described herein is an influence factor representative of the influence that an action person may have on a transaction, and more specifically, a factor that represents the influence that an action person may have on a transaction person, where such a factor may be calculated using a computerized device executing software instructions. When calculating influence factor, examples of the invention may use the steps and formula described herein. In other embodiments of the invention, some or all of the steps and formula described herein may be used. Still other embodiments may use alternate steps, equations, inputs, and values without departing from the spirit of the invention. Referring to FIG. 8, which illustrates a graphic diagram of the factors which may comprise influence factor in an embodiment of the invention. As illustrated, influence factor 800 may be calculated from at least one of: an expert factor 802; a star factor 804; and a relationship factor 806. Each of these factors may be comprised of other calculated factors which will be described herein. As an example, a relationship factor may be further comprised of a friendship factor 808, a collaboration factor 810, a connection factor 812, and a transaction correlation factor 814. The various factors and how to calculate them will now be described in detail.

### Friendship Factor

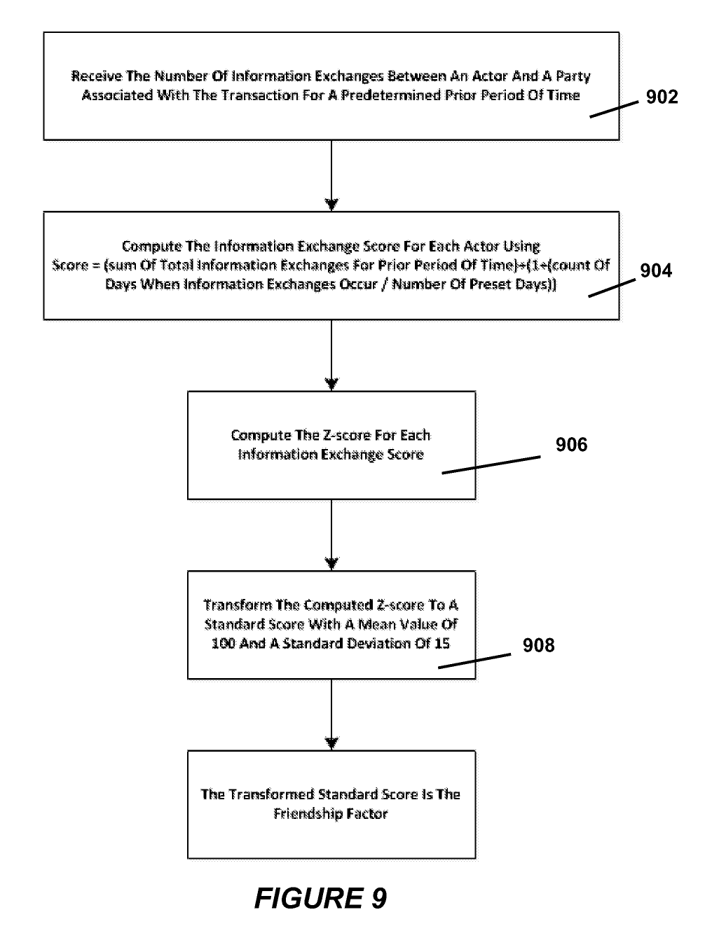

One skilled in the art will understand that a relationship factor may not indicate a particularly close relationship. In fact, some relationships considered by the relationship factor may be limited to a very small number of interactions or a distant connection between an action person and a transaction person. In an embodiment of the invention, friendship factor may represent a measurement of the action entities shared between the action person and a transaction person. In such an embodiment, the friendship factor is a measure of how frequently the action person and transaction person exchange information in the form of action entities as part of a relationship between the two parties. The friendship factor is relative to the type of action entity and transaction classification that applies to the transaction for which the factor is calculated. In embodiments of the invention, such a measurement may be performed over a predetermined period of time. When calculating friendship factor and friendship score, examples of the invention may use the steps and formula described herein. In other embodiments of the invention, some or all of the steps and formula described herein may be used. Still other embodiments may use alternate steps, equations, inputs, and values without departing from the spirit of the invention. Friendship factor may be calculated by a processor executing software instructions to normalize a friendship score calculated using Equation 3. FIG. 9 shows a flow chart of the steps and calculations performed by an embodiment of the invention to calculate friendship factor. As illustrated in FIG. 9, the number of information exchanges between an action person and a transaction person may be retrieved by a processor 902. At 904, software may then instruct the processor to calculate an information exchange score using Equation 3. The variable “information exchanges” may be a count of information exchanges during a predetermined number of days which involve both the action person and the transaction person. “Information days” may be the number of days that information exchanges occurred during a predetermined number of days, and “period days” may be the number of predetermined days. In an exemplary embodiment, 100 days may be a typical number used for period days.

Friendship Score=information exchanges*(1+(information days/period days)) Equation 3

When a friendship score is calculated for each action person, z-scores may then be computed from the friendship scores in step 906. These z-scores may then be transformed to standard scores with a mean value of 100 and a standard deviation of 15 as illustrated at 908. The resulting values are the friendship factors 808 which may be combined with other factors as illustrated in FIG. 8. As with other transformation to standard scores described herein, other mean and standard deviation values may be used without departing from the spirit of the invention.

### Transaction Correlation Factor

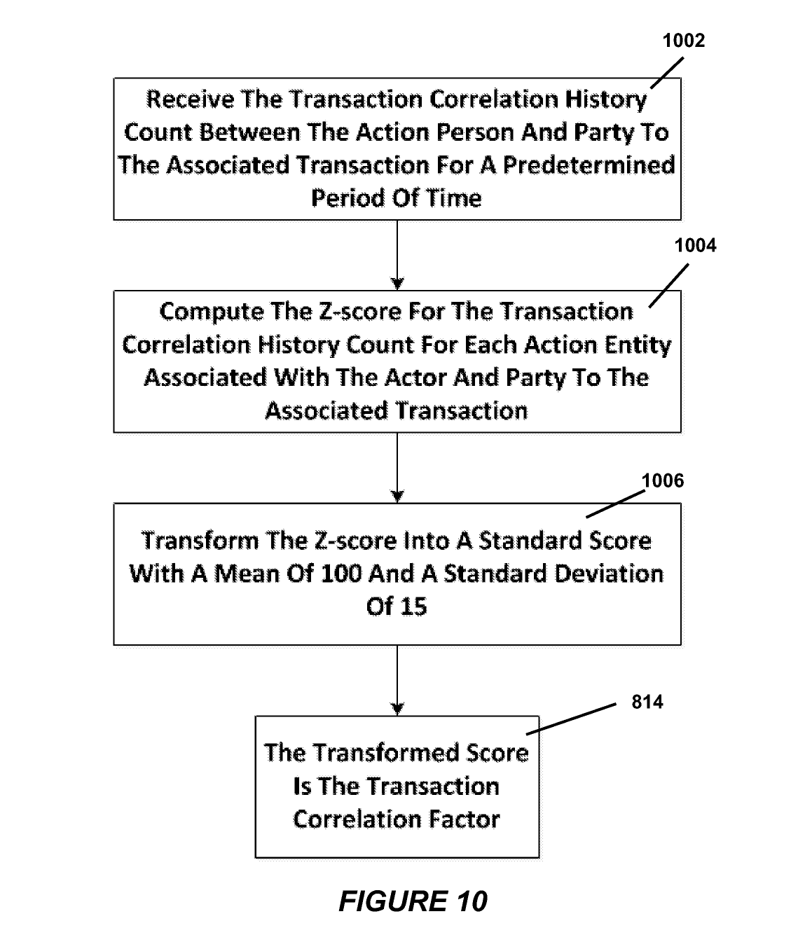

In an embodiment of the invention, transaction correlation factor may represent the count of the relevant action entities that are shared between an action person and the transaction person for a transaction during a pre-determined number of days prior to when the transaction correlation factor is calculated for the said transaction. As used herein, a relevant action entity means an information exchange that is classified as relevant to a particular transaction as determined by an embodiment of the invention through the application of a minimum relevance factor as described herein. When a transaction occurs and action entities are determined to be relevant for that transaction, these relevant action entities are recorded for each transaction. When calculating transaction correlation scores and factors, examples of the invention may use the steps and formula described herein. In other embodiments of the invention, some or all of the steps and formula described herein may be used. Still other embodiments may use alternate steps, equations, inputs, and values without departing from the spirit of the invention. When calculating transaction correlation factors, an embodiment of the invention analyzes these recorded transactions between action person and transaction person to calculate the count of relevant action entities shared between these parties. This calculated count is used to calculate the transaction correlation factor for the transaction which has occurred. As is illustrated in FIG. 10, a transaction correlation history count may be calculated by the processor 102 by adding together the number of action entities taking place between the action person and a party to the transaction over a predetermined period of time that are relevant to the transaction 1002. The processor may perform software instructions to compute a z-score for each such transaction count 1004. When the z-score computations are complete, the scores are transformed to standard scores with a mean of 100 and a standard deviation of 15 1006. The resultant standard scores are the transaction correlation factors 814 for each action person with regard to the transaction being evaluated.

### Collaboration Factor

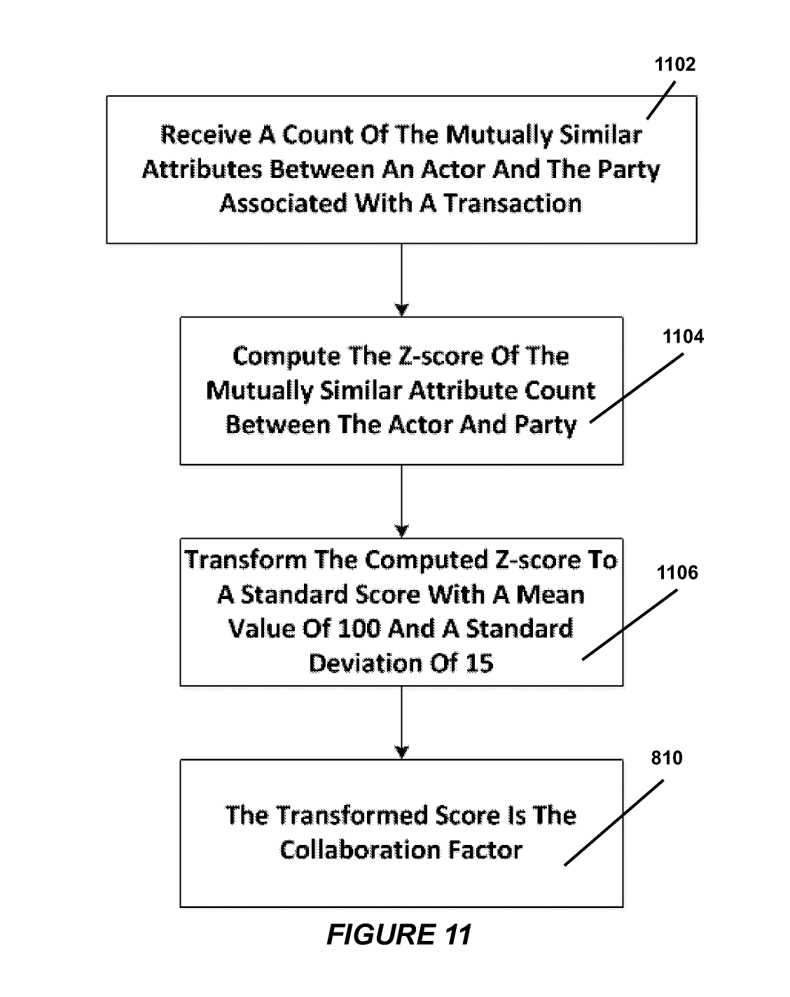

In embodiments of the invention, collaboration factor represents the number of similar attributes that are found between an action person performing an action entity related to a transaction and the transaction person for a transaction being evaluated. When calculating collaboration scores and factors, examples of the invention may use the steps and formula described herein. In other embodiments of the invention, some or all of the steps and formula described herein may be used. Still other embodiments may use alternate steps, equations, inputs, and values without departing from the spirit of the invention. Referring to FIG. 11, in an embodiment of the invention, a count of mutually similar attributes may be generated by a processor 102 executing software instructions to sum such attributes for each action person performing an action related to the transaction being evaluated 1102. Determination of mutually similar attributes may be based on social profiles of an individual in comparison with another individual. In such an embodiment of the invention, examples of similarity attributes may range from common schools or colleges, places of residence, employers, professional organizations, and other such common experiences. Such attribute information may be received by an embodiment of the invention from various social portals and may vary in content and context according to the specific attributes of each portal. Such an embodiment of the invention may generate a non-common attribute count. Embodiments of the invention may apply weighting factors to categories of similarity attributes to account for the likelihood of a higher or lower than normal level of connection associated with certain categories of similarity attribute. A processor 102 may perform software instructions to compute a z-score for each such mutually similar attribute count 1104. When the z-score computations are complete, the scores may be transformed to standard scores with a mean of 100 and a standard deviation of 15 1106. The resultant standard scores are the collaboration factors 810 for each action person with regard to the transaction being evaluated. These collaboration factors may be combined with other factors as illustrated in FIG. 8.

### Connection Factor

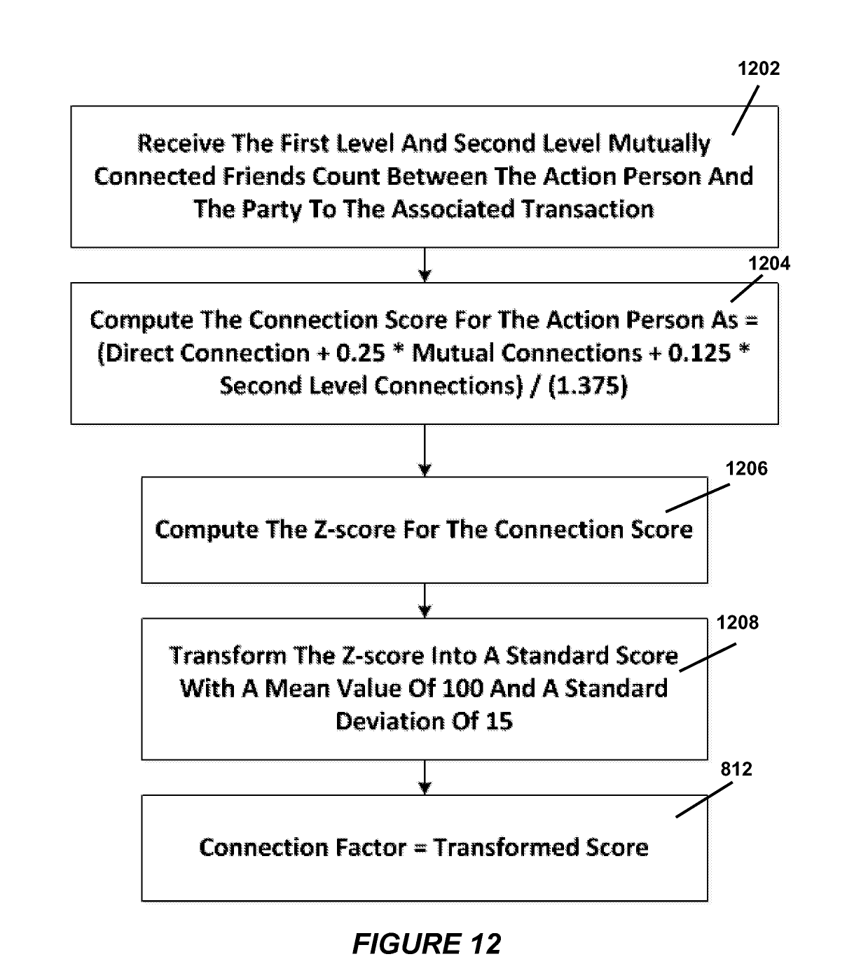

Connection factor represents the number of mutual connections and mutual acquaintances that exist between an action person and transaction person. This factor may be used to represent the level of connectedness that an action person and the transaction person have to each other within their respective social circles. Connections between action persons and transaction persons are organized into direct, first level and second level connections. An example of a direct connection may be a direct friendship, a first level connection may be the friend of a friend, and a second level connection may be a friend of a friend of a friend. When calculating connection factors and scores, examples of the invention may use the steps and formula described herein. In other embodiments of the invention, some or all of the steps and formula described herein may be used. Still other embodiments may use alternate steps, equations, inputs, and values without departing from the spirit of the invention. Referring to FIG. 12 which illustrates a flow chart of an embodiment of the invention. In step 1202, a processor may execute software instructions to receive data representing friendship relationships between the action person and the party to a transaction. In step 1204, a processor may execute software instructions to process direct, first, and second level connection information using Equation 4. First level connections represent a closer connection than second level connections and thus are accorded a greater weight when calculating a connection score. In an exemplary embodiment of the invention, these different weights are generated using factors of 0.25 and 0.125 as illustrated in Equation 4 below.

Connection Score=(L_{f}+0.25*M_{f}+0.125*Mₛ)/(1.375) Equation 4

The variable L_{f} may represent a direction connection between the action person and the transaction person. This variable may be set to 1 if there is a direct connection between the action person and the transaction person and 0 if there is not. The variable M_{f} may represent the number of first level connections between the action person and the transaction person. Mₛ may represent the number of second level connections between the action person and the transaction person. In an embodiment of the invention, data regarding the direct, first, and second level connections may be received by the processor 102 which executes software instructions to perform the algorithm of Equation 4. Referring again to the flowchart of FIG. 12, in step 1206, a processor may execute software instructions to compute the z-score for connection scores calculated in step 1204. In step 1208, the processor may execute software instructions to transform the computed z-scores into standardized scores with a mean value of 100 and a standard deviation of 15. The result is the connection factor 812 for action persons that perform an action entity related to the transaction for which the connection factor is being calculated by an embodiment of the invention.

### Relationship Factor

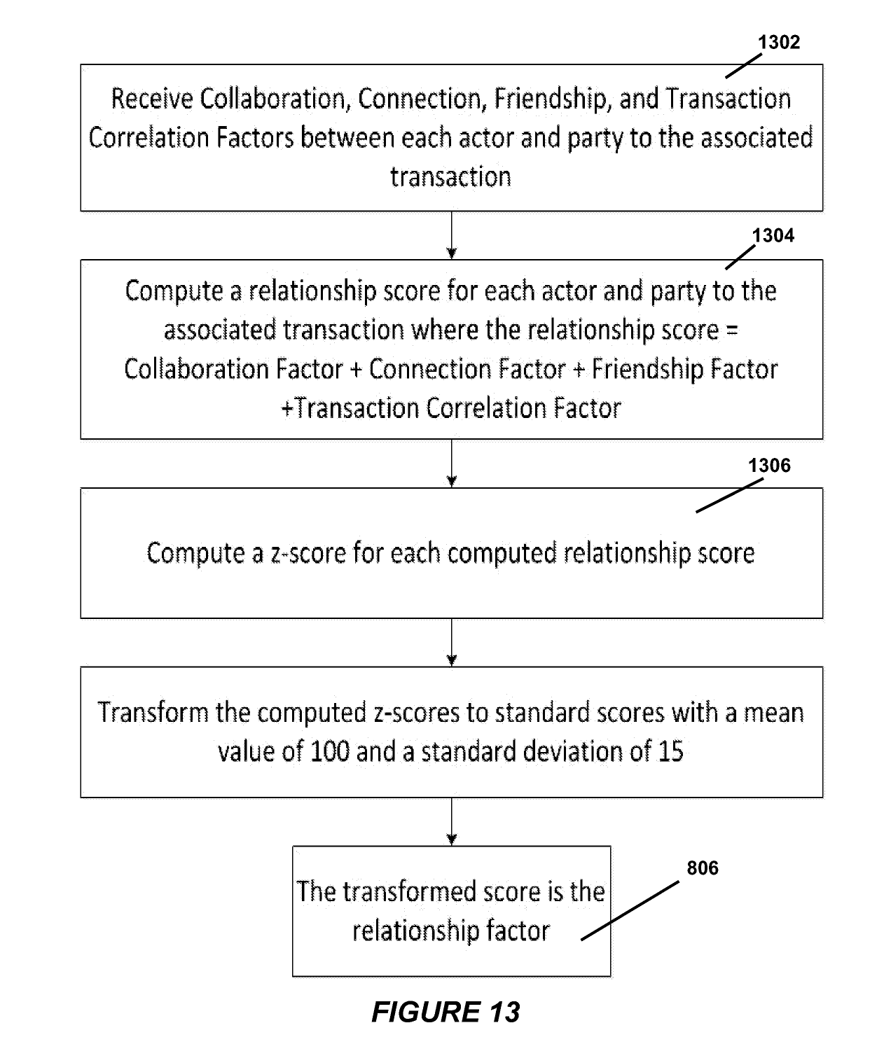

Relationship factor represents the potential impact of the relationship between an action person and a transaction person of the transaction being evaluated on that transaction. Generally, a stronger or closer relationship between these two parties will result in a greater influence on whether a potential transaction person will participate in a transaction. When calculating relationship factors and scores, examples of the invention may use the steps and formula described herein. In other embodiments of the invention, some or all of the steps and formula described herein may be used. Still other embodiments may use alternate steps, equations, inputs, and values without departing from the spirit of the invention. As is illustrated in FIG. 8 at 806, relationship factor may be calculated by applying at least one of: friendship 808, collaboration 810, connection 812, and transaction correlation factors 814 to a relationship factor algorithm. A processor 102 may execute software instructions to calculate a relationship factor as described herein. As is shown in the flow chart of FIG. 13, collaboration, connection, friendship, and transaction correlation factors for each action person who performed an action entity related to the transaction may be received by the processor 1302. The processor may execute software instructions to sum at least one of these values to arrive at a relationship score for each action person 1304. In an embodiment of the invention, the processor may then compute a z-factor for each of the summed scores 1306. The z-factor scores may then be transformed to a standard score with a mean value of 100 and a standard deviation of 15. In such an embodiment, the resulting standard scores are the relationship factor 806 for each action person with regard to the transaction being evaluated.

Referring again to FIG. 8, relationship factor 806 is one of three factors that may be used to calculate an influence factor 800. The remaining two factors, star factor 804, and expert factor 802 will be described after the description of transaction worthiness herein but a brief explanation of star and expert factors is now provided to assist the reader in understanding the calculation of influence factor.

### Star and Expert Factor Overview

In embodiments of the invention, star factor and expert factor are two factors that are components of an action person's influence on the transaction person. These two factors are the result of celebrity and subject matter knowledge respectively of the action person. Unlike the factors that comprise the relationship factor, star factor and expert factor are based on historical information regarding the action person. In the case of star factor, information regarding the action person's ability to attract the attention of transaction persons to the action person's action entities may be gathered over a predetermined time period and used to derive a star factor value. Expert factor may be calculated using a combination of influence and relevance factors calculated for the action person's action entities. Because the expert factor is a measure of the action person's knowledge of a certain subject, the transactions used to calculate the influence and relevance factors used to derive the expert factor may be restricted to a certain transaction type category that represents the subject in which the influence of the action person's knowledge is to be measured.

### Influence Factor

Influence factor represents an aggregation of factors which together represent the influence exerted on a transaction by an action person. In embodiments of the invention, influence factor may be calculated with regard to a predefined transaction type and the transaction person. This may be the result of the use of star and expert factors which are calculated relative to a predetermined transaction type or category, and a relationship factor which is calculated as a factor between an action person who performed an action entity and the transaction person associated with the transaction for which the factors are being calculated. When calculating influence factors and scores, examples of the invention may use the steps and formula described herein. In other embodiments of the invention, some or all of the steps and formula described herein may be used. Still other embodiments may use alternate steps, equations, inputs, and values without departing from the spirit of the invention.

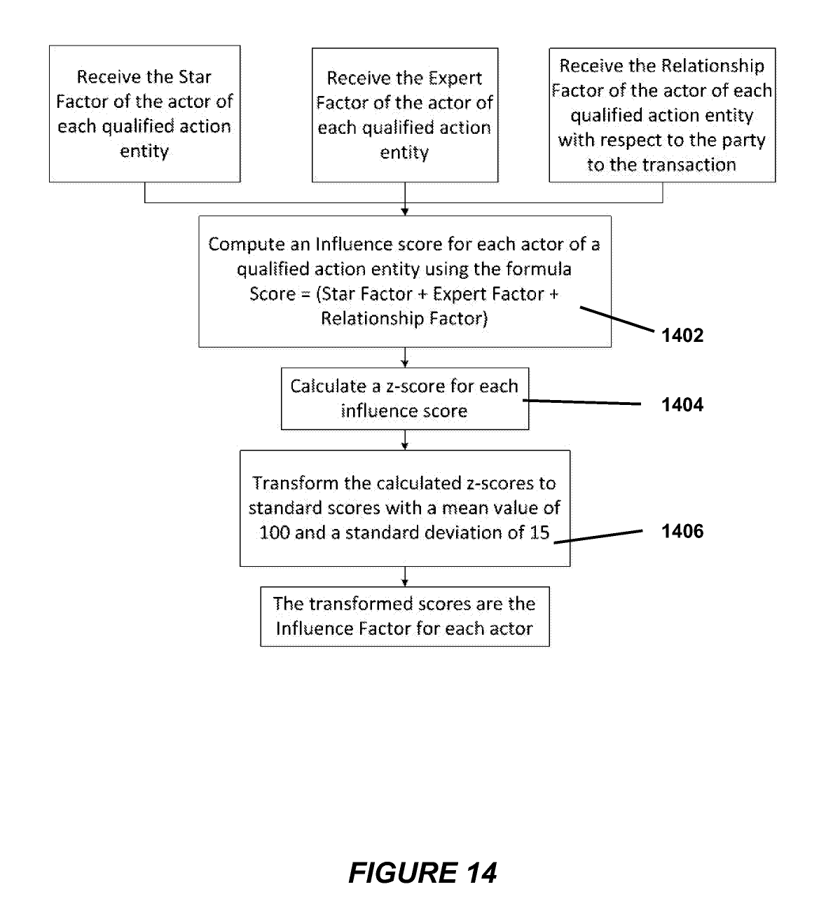

As is illustrated in FIG. 8, influence factor 800 combines at least one of: relationship factor 806; which it itself derived from at least one of: friendship 808; collaboration 810; connection 812; and transaction correlation factors 814; a star factor 804; and the expert factor 802 previously described. FIG. 14 illustrates an embodiment of the invention in which a processor may execute software instructions to sum at least one of these three factors for each action person who performed an action entity related to the transaction to form an influence score 1402 for the corresponding action person. In an embodiment of the invention, a z-factor for each value may be computed 1404 and the resulting z-factor scores transformed to a set of standard scores with a standard deviation of 15 and a mean value of 100 1406 which represent the influence factors for the action person.

### Impact Factor

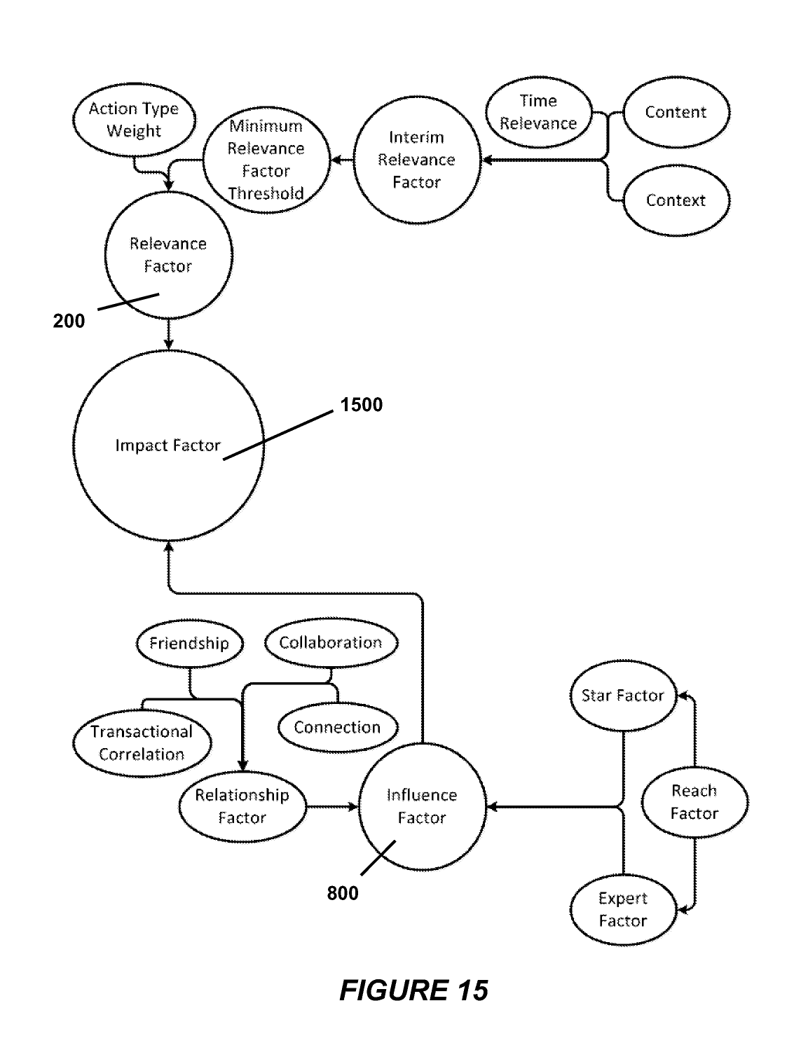

In an embodiment of the invention, impact factor refers to the calculation of an action entity's impact on a transaction based on the action entity's relevance and the action person's influence. When calculating impact scores and factors, examples of the invention may use the steps and formula described herein. In other embodiments of the invention, some or all of the steps and formula described herein may be used. Still other embodiments may use alternate steps, equations, inputs, and values without departing from the spirit of the invention. Referring to the diagram of FIG. 15, impact factor 1500 is calculated using at least one of: relevance factor 200, which as described earlier herein reflects the relevance between an action entity and a transaction, and influence factor 800, which is a representation of the influence that an action person has on a transaction by virtue of the action person's relationship with the transaction person, the action person's popularity (star factor described in more detail later herein), and the action person's expertise with regard to the subject of transaction (expert factor, also described in more detail later herein).

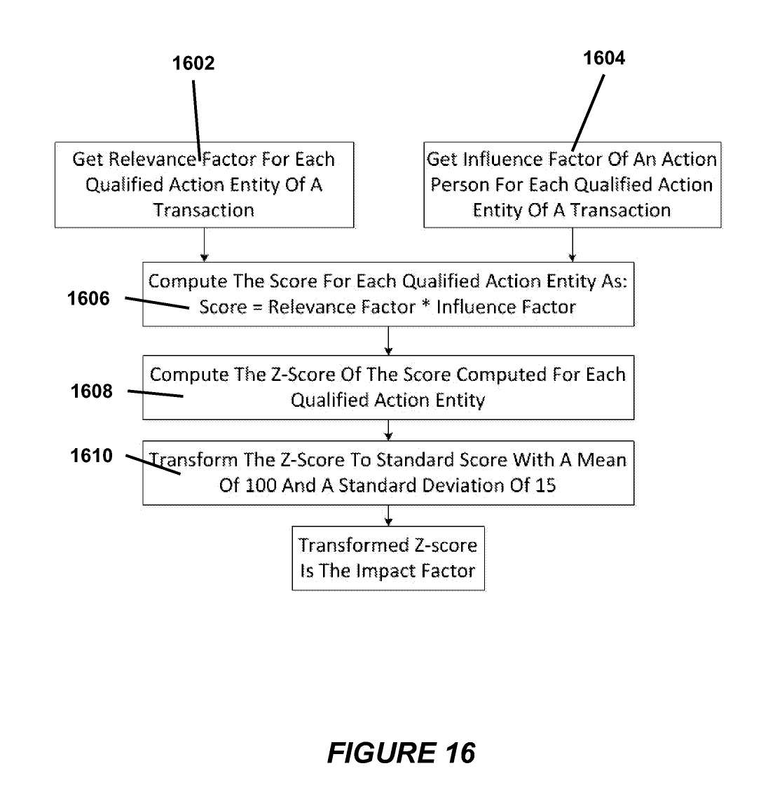

In an embodiment of the invention, a processor 102 may execute software instructions to perform the steps illustrated in FIG. 16. In step 1602, the processor may receive the relevance factor for each qualified action entity of a transaction. In step 1604, the influence factor of an action person for each qualified action entity of a transaction may be received. In an embodiment of the invention, in step 1606, the processor 102 calculates an impact score for each qualified action entity by performing software steps that multiply the received relevance of the action entity and the influence factor of action person associated with that action entity. In step 1608, a z-score is computed for each resultant value. In step 1610, the z-scores are transformed to standard score values with a mean value of 100 and a standard deviation of 15. These standard scores are impact factors for the action entities for which they are calculated.

### Action Entity Transaction Worthiness

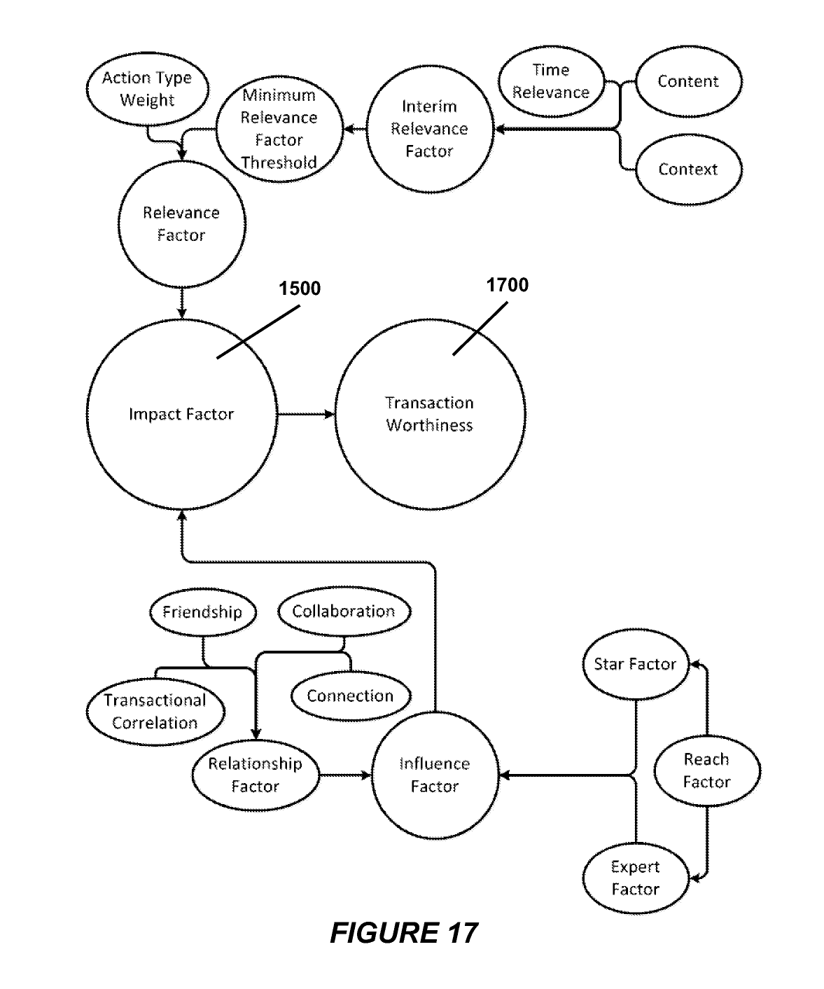

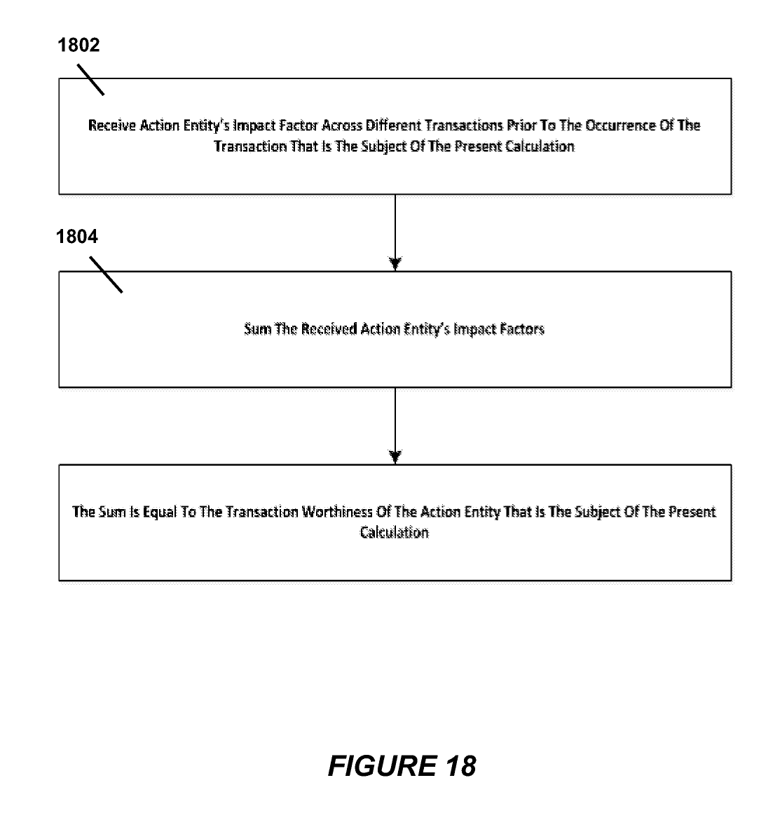

Referring to FIG. 17, in embodiments of the invention, the transaction worthiness 1700 of an action entity is a value derived from the aggregation of an action entity's impact factors 1500 across transactions that have occurred during a predetermined period of time previous to the transaction for which action entity transaction worthiness is being calculated. When calculating action entity transaction worthiness, examples of the invention may use the steps and formula described herein. In other embodiments of the invention, some or all of the steps and formula described herein may be used. Still other embodiments may use alternate steps, equations, inputs, and values without departing from the spirit of the invention. An exemplary embodiment of the invention may calculate action entity transaction worthiness upon the occurrence of each transaction wherein the action entity earned an impact factor. Referring to the flow chart of FIG. 18, in such an embodiment, a processor 102 may perform step 1802 in which the processor receives an action entity's impact factor across different transactions that occurred prior to the present transaction. In step 1804, the processor executes software instructions to perform Equation 5, computing the sum of action entity impact factors for received transactions that occurred during a predetermined period of time previous to the transaction for which action entity transaction worthiness is being calculated. The resulting sum is the action entity's transaction worthiness.

Action Entity Transaction Worthiness=Sum(Action Entity's Impact Factor of all input transactions except the current transaction) Equation 5

### Action Entity Transaction Worthiness Factor

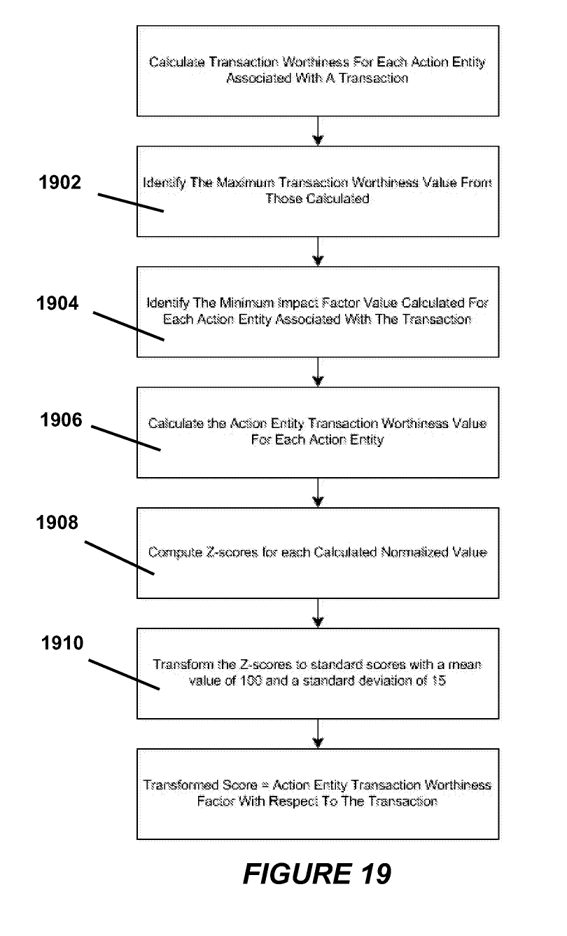

In embodiments of the invention the action entity transaction worthiness factor represents the normalized value of an action entity's transaction worthiness among the other action entities that qualify as action entities for a transaction. When calculating action entity transaction worthiness scores and factors, examples of the invention may use the steps and formula described herein. In other embodiments of the invention, some or all of the steps and formula described herein may be used. Still other embodiments may use alternate steps, equations, inputs, and values without departing from the spirit of the invention. As shown in FIG. 19, in such an embodiment, after calculating transaction worthiness for each action entity as described earlier herein, the processor 102 executes software instructions to identify the maximum calculated transaction worthiness value in step 1902. The processor 102 executes software instructions to identify the minimum impact factor value calculated for each action entity associated with the transaction in step 1904. These calculated values are max transaction worthiness score and minimum value of action entities impact factor respectively. In such an embodiment, the processor 102 executes software instructions in step 1906 to calculate action entity transaction worthiness factors using Equation 6 where the transaction worthiness score and minimum value of action entities impact factor are those detailed above and the value of the action entity's transaction worthiness is that value described in the previous section herein.

Action Entity Transaction Worthiness Normalized Value=(Action Entity's Transaction Worthiness/max(Transaction Worthiness Score))*(minimum value of Action Entities Impact Factor) Equation 6

In step 1908 a z-score is computed for the resulting action entity transaction worthiness and then transformed in step 1910 to a standard score with a mean value of 100 and a standard deviation of 15. The transformed score is the action entity transaction worthiness factor for an action entity with respect to the transaction for which action entity transaction worthiness is being calculated.

### Importance Factor

In embodiments of the invention, importance factor refers to the calculation of an action entity's importance with respect to each transaction where the action entity is found relevant as described previously herein.

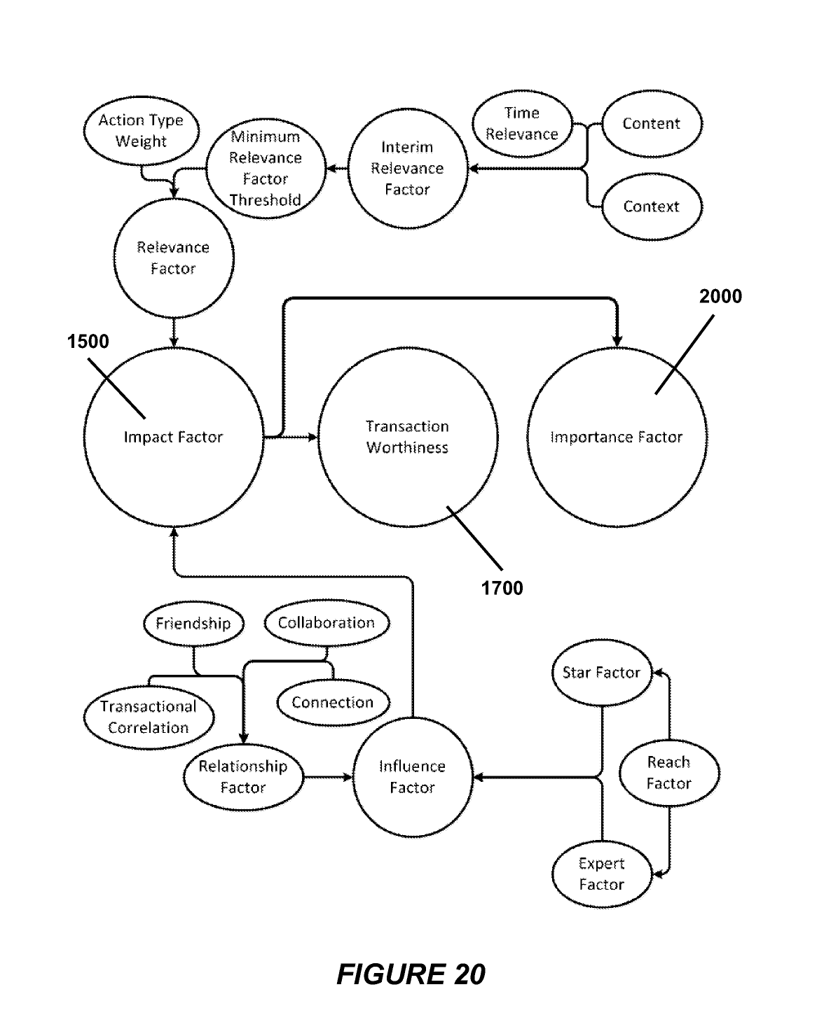

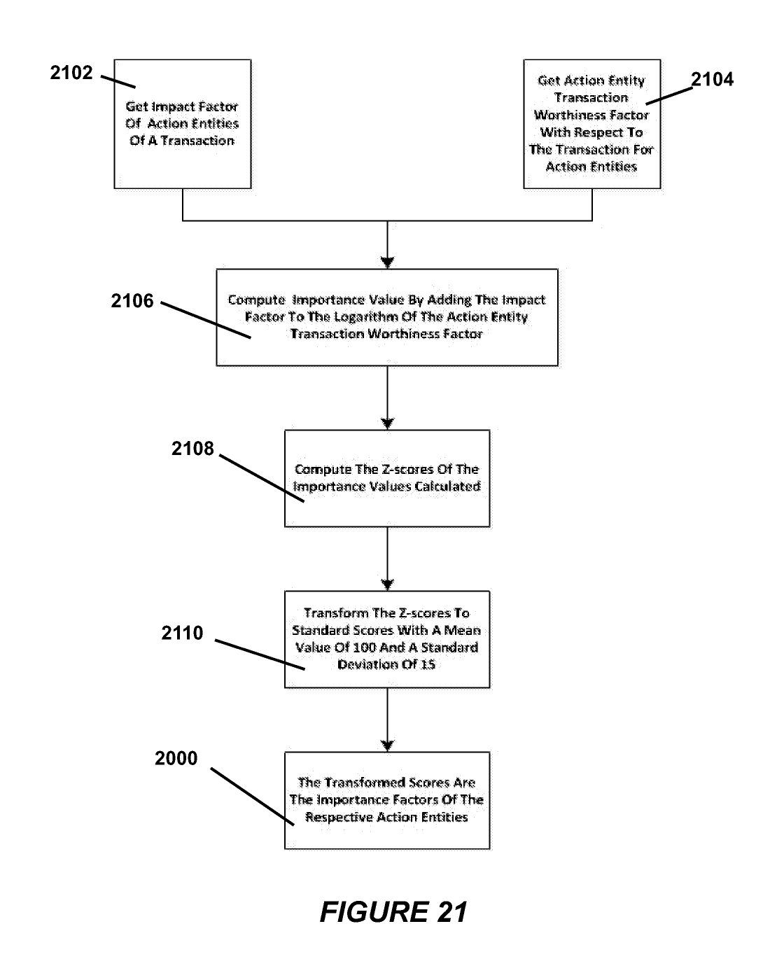

Importance factor may be the most essential factor for identifying the importance of an action entity with regard to the occurrence of a transaction. When calculating importance factor and importance value, examples of the invention may use the steps and formula described herein. In other embodiments of the invention, some or all of the steps and formula described herein may be used. Still other embodiments may use alternate steps, equations, inputs, and values without departing from the spirit of the invention. Referring to the diagram of FIG. 20 which illustrates the relationship between importance factor and the factors used to derive that importance factor in an embodiment of the invention. As is shown, importance factor 2000 is calculated using impact factor 1500 and transaction worthiness 1700. Importance factor considers the transaction worthiness of an action entity and impact factor of the action entity with respect to a transaction. Referring to FIG. 21, in an embodiment of the invention, a processor 102 executes software instructions to calculate importance factor as previously described herein in step 2102. In step 2104, a processor executes software instructions to calculate transaction worthiness factor as previously described herein. In step 2106, a processor executes software instructions to calculate an importance value score using Equation 7. In step 2108, the processor executes software instructions to compute a z-score for each calculated score. In step 2110, the resultant set of z-scores may be transformed to have a standard score with a mean of 100 and a standard deviation of 15. The transformed values represent the importance factor 2000 of action entities with respect to the transaction for which the impact and transaction worthiness.

Importance Value=Impact Factor+log(Action Entity Transaction Worthiness Factor) Equation 7

### Time Factor

A time factor may also be used to limit transaction or action entity data considered for analysis by an embodiment of the invention. A time factor may also be used to limit the factor data reported to a user of the invention to those action entities or transactions that occur during a defined time period. Time factor should not be confused with time relevance described herein which may be used to determine the relevance of an action entity to a transaction based on the passage of time between the two. When calculating time factor, examples of the invention may use the steps and formula described herein. In other embodiments of the invention, some or all of the steps and formula described herein may be used. Still other embodiments may use alternate steps, equations, inputs, and values without departing from the spirit of the invention.

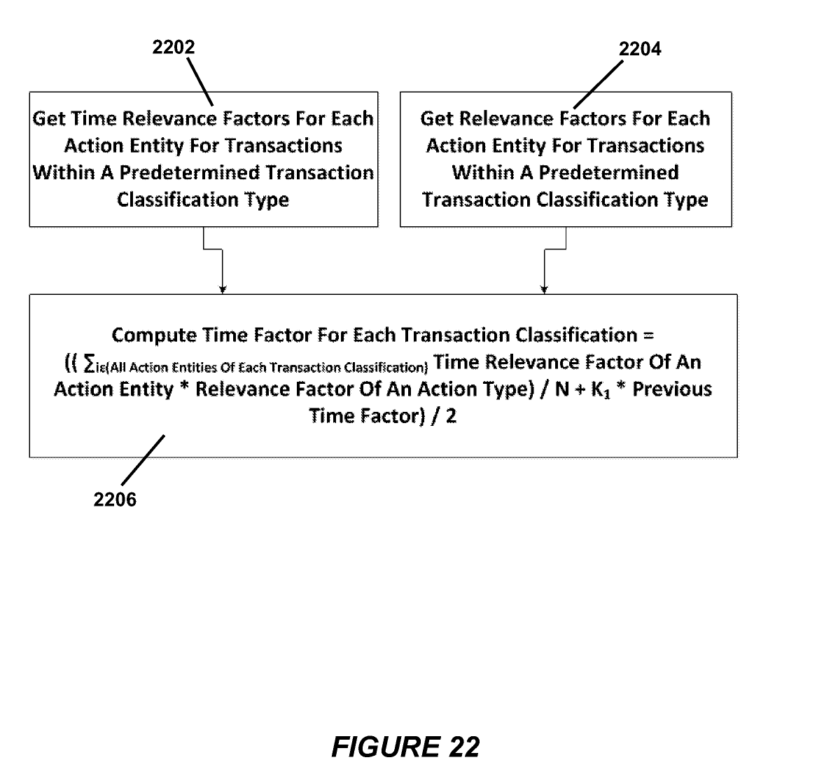

Referring to FIG. 22, time factor is partially based on the time relevance factors calculated for those action entities associated with transactions that fall within a predetermined transaction classification type. In step 2202 a processor may execute software instructions to receive time relevance factors calculated according to the method previously described herein, for each action entity associated with those transactions that fall within a predetermined transaction classification type. In step 2204, a processor may execute software instructions to receive a relevance factor for those action entities for which a time relevance factor was received in step 2202. In step 2206, a processor may execute software instructions to compute a time factor for each transaction classification based upon the time relevance factors and relevance factors received in steps 2202 and 2204 and Equation 8.

Time Factor For Transaction Classification=((Σ_{iε(A)}T_{rf}*R_{f})/N+K1*T_{ptf})/2 Equation 8

Referring to Equation 8, A may be equal to all action entities of each transaction classification, T_{rf} may be the time relevance factor of an action entity, R_{f} may be the relevance factor of an action type, N may represent the total number of action entities identified in the variable A, and T_{ptf} may be a previous time factor. K1 may represent an arbitrary constant which may have a value ranging from about 0-1. In embodiments of the invention, K1 may initially be set to the value of 1 and adjusted between about 0-1 as needed to avoid a drastic change in the calculated time factor between transaction classifications. In embodiments of the invention, the previous time factor (T_{ptf}) may be set to 0 when a time factor for transaction classification is initially calculated.

### Action Type Minimum Relevance Factor Threshold

A minimum relevance factor threshold 206 (see FIG. 2) may be computed based upon transaction type or classification, or further may be computed based on geography or similar parameters as may be relevant to specific transaction types. When calculating minimum relevance factor threshold, examples of the invention may use the steps and formula described herein. In other embodiments of the invention, some or all of the steps and formula described herein may be used. Still other embodiments may use alternate steps, equations, inputs, and values without departing from the spirit of the invention. Referring again to FIG. 2, the minimum relevance factor threshold may be applied to the interim relevance factor 204 to limit those interim relevance factor values being further factored into the relevance factor 200 to those that satisfy the minimum relevance factor threshold criteria. The minimum relevance factor threshold may be computed using Equations 9 and 10 where Rₗ may represent an action type minimum relevance factor threshold. The variable A may represent all action entities of each transaction classification of all transactions, R_{irf} may be an intermediate recalibrated relevance factor, Rₚ₁ may be a previous relevance factor initially calculated using Equation 11 upon recording of the transaction and action entity information of the first qualifying transaction and thereafter recalculated as the previously computed value of Rₗ, Rᵢ may be the calculated relevance factor for an action entity i, Rₘₐₓ may be a maximum relevance factor among all the action entities, N may be the total number of action entities identified in A, and K₂ may be a constant in the range of about 0-1.

R_{irf}=(i)=(Rᵢ*100)/Rₘₐₓ Equation 9

Rₗ=((Σ_{iεA}R_{irf}(i))/N+K2*Rₚₗ)/2 Equation 10

Rₚₗ=Σ_{iεA}R_{irf}(i)/N Equation 11

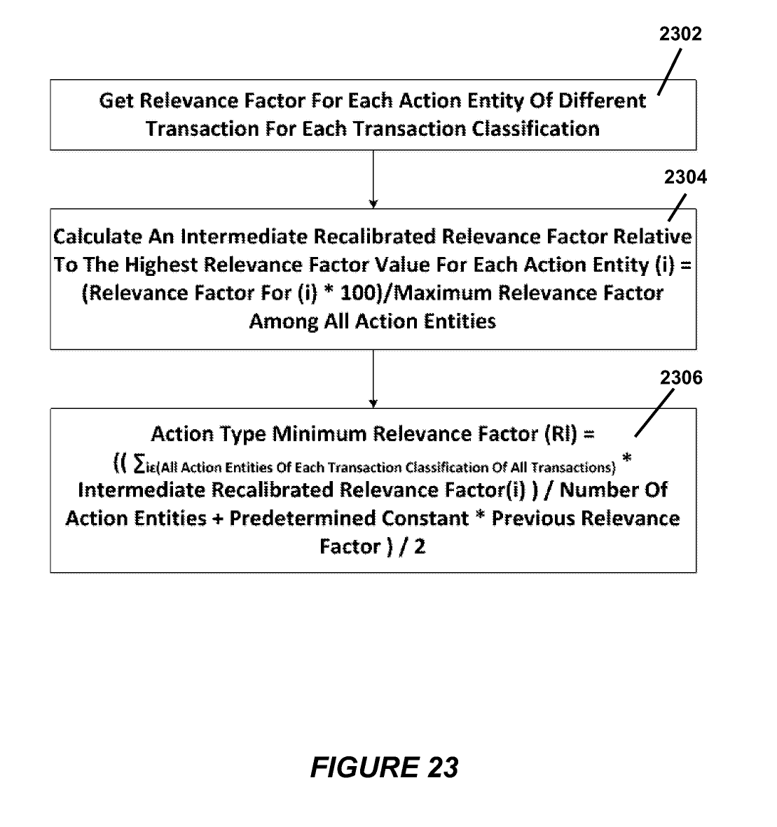

The intermediate relevance factor (R_{irf}) may be taken for each action entity grouped by transaction classification. An example of a classification system is the NAICS system previously described. Referring to the exemplary embodiment of the invention shown in FIG. 23, a processor may perform software instructions to receive the relevance factor for each action entity of the transactions of each transaction classification in step 2302. Each intermediate relevance factor may be recalibrated relative to the highest value from each grouping by the processor executing instructions to perform Equation 9 in step 2304. The action type minimum relevance factor is computed in step 2306 using Equation 10 by taking an algorithmic average of the recalibrated values to obtain an intermediate relevance factor value. An algorithmic average of this intermediate relevance factor value and previous action type minimum relevance factor value may be computed to obtain the action type minimum relevance factor 206.

### Action Type Weight Factor

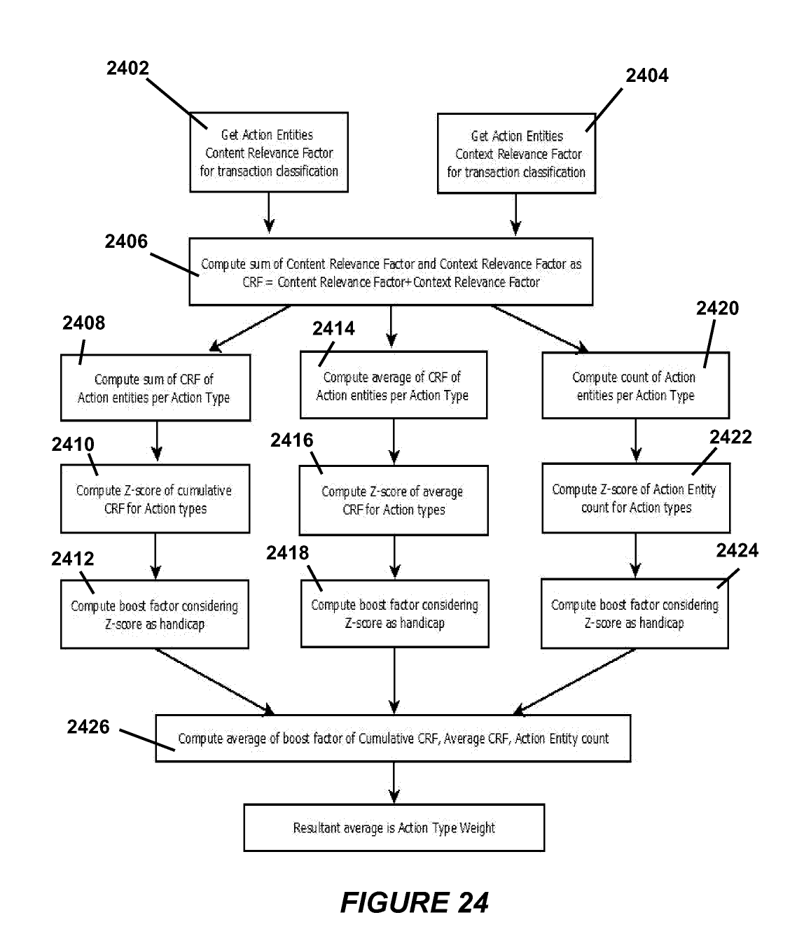

An action type weight factor may also be used to normalize a boost factor applied to each qualified entity based on time factor and minimum relevance factor for the given transaction classification based on the action type. An action type weight factor may be calculated in terms of boost factor for each action type with respect to a transaction classification. When calculating action type weight, examples of the invention may use the steps and formula described herein. In other embodiments of the invention, some or all of the steps and formula described herein may be used. Still other embodiments may use alternate steps, equations, inputs, and values without departing from the spirit of the invention. Referring to FIG. 24, which illustrates a flow chart of an embodiment of the invention, a processor 102 executes software instructions to gather content relevance factors for action entities related to a transaction classification 2402. Context relevance factors are gathered for those action entities related to the same transaction classification 2404. For each action entity, the sum of the gathered content relevance and context relevance factors may be computed by the processor in step 2406. The sum of the previously summed content and context relevance factors for each group of action entity types that are present for those factors gathered is calculated 2408. In an embodiment of the invention, a z-score may then be calculated for each action entity type 2410. In step 2412, a processor executes software instructions to compute a boost factor considering the calculated z-score as a handicap using Equation 12. In step 2414, an average value of the previously summed content and context relevance factors for each group of action entity types that are present for those factors gathered is calculated. In step 2416, a processor executing software instructions computes a z-score for the average values for each action entity type. In step 2418, a boost factor is computed considering the calculated z-score as a handicap using Equation 12. In step 2420, a processor executes software instructions to calculate a count of action entities per action entity type. In step 2422, this count is used to compute a z-score of action entity counts for each action entity type. In step 2424, these z-scores are used to compute a boost factor for each action entity type using Equation 12.

Boost Factor=100−(z-score)*100 Equation 12

Once the boost factors have been computed for the sum 2412, average 2418, and count 2424 values, an average of the three boost factors is computed in step 2426. The process of FIG. 24 may be repeated for each action entity type and the resultant average values are the action type weights for the action entity type for which the value was calculated. Because the calculated action type weights are derived from one transaction classification, the process of calculating action entity weights may be repeated for each transaction classification type. The result may be a collection of action entity type weights for each transaction classification type.

### Reach Factor

An action person's reach factor is a measurement of that action person's exposure in terms of how many persons and entities access that action person's action entities. For example, if a well known person were to write an article about the subject of a transaction, there may be a relatively large number of persons or organizations that read (access) that article. Conversely, if a relatively unknown person were to write a similar article about the subject of that same transaction, there may be some persons or organizations that read (access) that article but it would be likely that the number of accesses for the lesser known author's article would be fewer than the article by a famous person. An additional impact on the exposure of an action entity may be the location or venue associated with the action entity, in such a situation, an action person's reach may be greater within an audience that is concentrated within a particular geographic location. An action person's reach may also be greater within a particular demographic group for action entities that are more likely to appeal to that group. For example, even a well known person may have a low reach factor if the action entity relative to the transaction is located in a relatively obscure location, whereas, a lesser known person whose action item was located in a location with high visibility to transaction parties may have a higher reach factor. In another example, a nationally known sports figure may have a lower reach factor than a local college athlete in a small college town where that college athlete attends school. As a result, a reach factor calculation may result in a lower reach factor for the famous person's action entity (article) relative to the access factor calculated for the lesser known person's article for a given target audience if that lesser known person's action item generates a greater number of accesses than the famous person in that audience. When calculating reach factor and reach score, examples of the invention may use the steps and formula described herein. In other embodiments of the invention, some or all of the steps and formula described herein may be used. Still other embodiments may use alternate steps, equations, inputs, and values without departing from the spirit of the invention.

Referring to the flow chart of FIG. 24, in an embodiment of the invention, reach factor may be calculated by a processor 102 executing software instructions which cause the processor to calculate a count of how many persons and entities have accessed that action person's action entities prior to the action entities related to the currently evaluated transaction 2502. In embodiments of the invention, such persons and entities may be subscribers to a system or service offering that embodies the current invention. The processor 102 may receive a similar count for each action person who performs an action entity related to the currently evaluated transaction. In step 2504, the processor may receive a count of action entities performed by the action person. In addition to information related to action entities, demographic and geographic information may be received by the processor in step 2506. In step 2508, a reach score may be calculated using Equation 13 where A(t1t2) may represent all action entities the action person performed within the time range of t1 to t2.

Reach Score=avg(Σ_{iεA(t1,t2)}(Unique users accessing i)) Equation 13

The processor may perform software instructions to calculate a z-score for each action person's calculated reach score and the calculated z-scores may then be transformed into standard scores with a mean value of 100 and a standard deviation of 15. The resulting standard scores are the reach factors for the action persons for which the processor received a count of accesses and action entities. Because an action person's exposure and thus reach factor may be influenced by geographic, demographic, and time periods that transpire between action entities and a transaction, embodiments of the invention may filter the received action entity information obtained in steps 2502 and 2504 by action entity characteristics such as geography, demographic characteristics, and elapsed time as illustrated at 2510.

### Action Person Transaction Worthiness

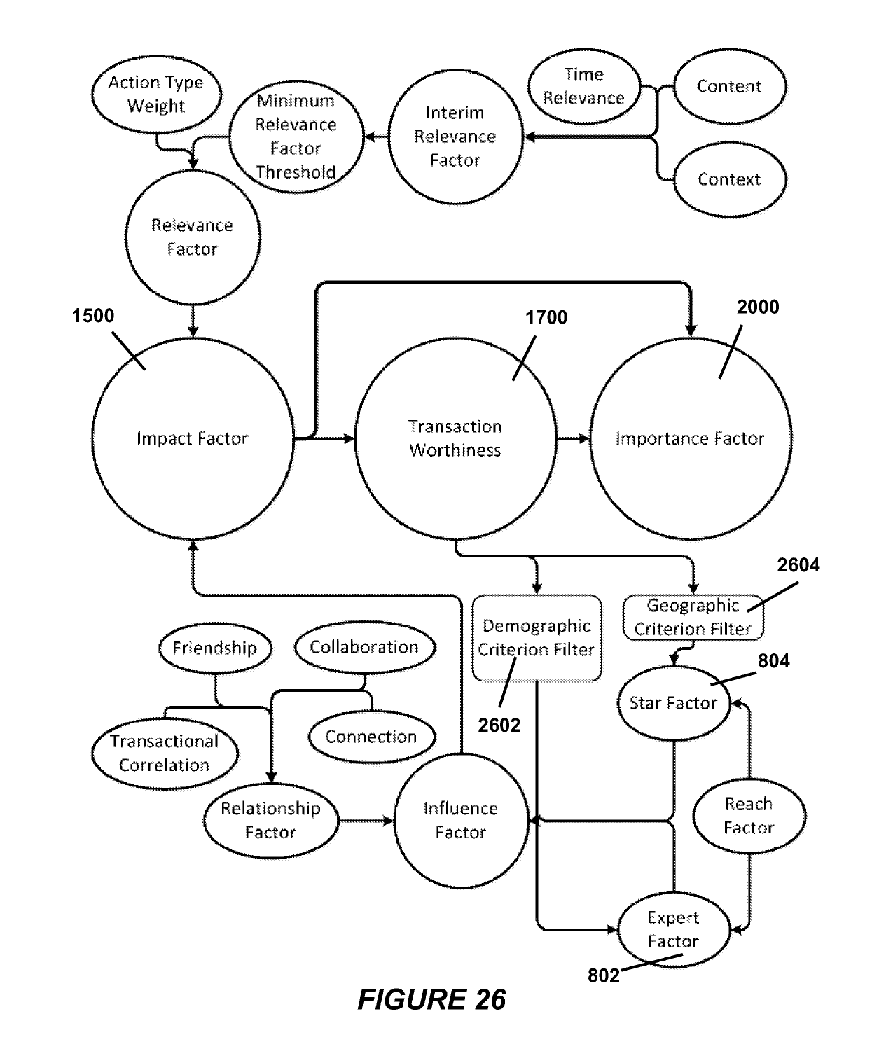

Referring to FIG. 26, in embodiments of the invention, an action person transaction worthiness value 1700 may be used to represent an action person's past impact on transactions. Transaction worthiness may be calculated to include all action entities that were created by the action person by considering impacts of action entities against all transaction types or limited to those impacts of the action entities that are relevant to a transaction type as determined by use of a minimum relevance factor as described herein. Additionally, transaction worthiness may be filtered by applying certain filters 2602 and 2604 including, but not limited to, time period, geographic location, demographic characteristics, and type of transaction. In an exemplary embodiment of the invention, applying a filter to such a geographic location, a transaction worthiness rating for an action person may be limited to reflect past input as the result of action entities or transactions from a location or region specified by the filter. Filtering may be beneficial in circumstances where a user is interested in the action person's rating for a transaction type that may be geographically limited in scope. An example of such a geographic limitation may be transactions or action entities related to a builder of houses located in the Midwest United States. If a user of the invention is interested in determining an action person's transaction worthiness regarding that homebuilder, action entities regarding homebuilders located in the state of Oregon, which is not located in the Midwest, may be filtered out to more accurately reflect the relevance of action entities that are geographically related to the transaction and the resulting geographically varying influence of the action person.

When calculating action person transaction worthiness, examples of the invention may use the steps and formula described herein. In other embodiments of the invention, some or all of the steps and formula described herein may be used. Still other embodiments may use alternate steps, equations, inputs, and values without departing from the spirit of the invention. Action person transaction worthiness may be calculated by a processor executing software instructions upon occurrences of each transaction where an action entity of the transaction person has earned a transaction worthiness score. The action person transaction worthiness value is the sum of action entity transaction worthiness obtained by action entities of the transaction person prior to the transaction for which an action person transaction worthiness is calculated.

As illustrated in FIG. 26, transaction worthiness 1700 is a value used to calculate other factors described herein. These additional factors may comprise star factor, expert factor, and as the result of star and expert factors, impact factor 1500. In addition, an impact factor may be combined with transaction worthiness to produce an importance factor 2000 as was previously described herein. Because transaction worthiness may be filtered as described earlier, factors calculated using transaction worthiness may also be correspondingly filtered to reflect the impact of time, geographic, demographic or subject on the action entity's relationship to a transaction.

### Star Factor

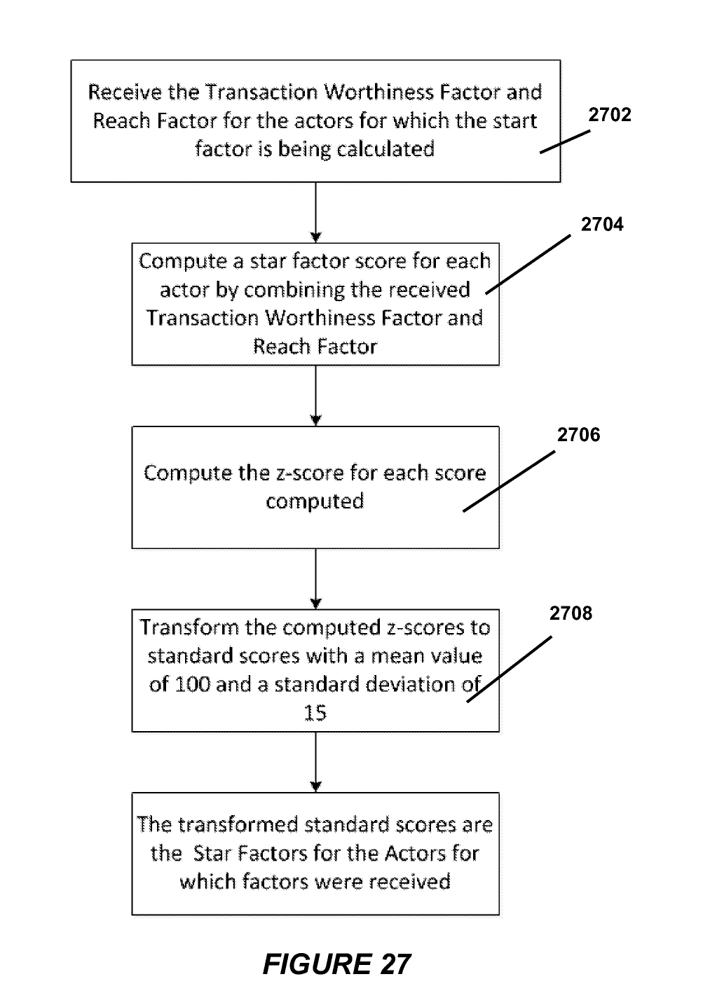

Star factor 804 is a measurement of an action person's potential reach and influence on a transaction person. This potential reach and impact are calculated from reach and transaction worthiness values during the analysis of prior transactions involving the action person. When calculating star factor, examples of the invention may use the steps and formula described herein. In other embodiments of the invention, some or all of the steps and formula described herein may be used. Still other embodiments may use alternate steps, equations, inputs, and values without departing from the spirit of the invention. Referring to FIG. 27, in an embodiment of the invention, in step 2702 a transaction worthiness factor from the analysis of an action person's prior action entities is received by a processor executing software steps to calculate star factor according to the algorithm described herein. Also received in step 2702 is the action person's reach factor calculated as previously described. In step 2704, the processor executes software instructions to perform Equation 14. In Equation 14, the received transaction worthiness and reach factor are multiplied for each action person with an action entity related to the currently analyzed transaction to obtain a star score for each action person.

Star Score=Action Person's Transaction Worthiness*Reach Factor Equation 14

In step 2706, a z-score may be computed by the processor for each of the resulting star score values. In step 2708, the processor transforms the star score to standard factor with a mean value of 100 and a standard deviation of 15. The resultant factors are the star factors for each action person analyzed as illustrated as 804 in FIG. 8.

As star factor is primarily an analysis of an action person's past actions and the effect of the action person's celebrity on the ability of the action person's action entities to influence transaction persons, the star factor of an action person may vary depending upon the subject of the transaction, the demographic characteristics of the transaction person, the geographic characteristics of the transaction, and the time sensitivity of the subject of the transaction. To account for the effect of such characteristics on otherwise identical action entities, the transaction worthiness value applied to calculating the star factor may be filtered to restrict the impact factors used to calculate transaction worthiness to those factors that are characterized by the filtered parameter. For example, using the homebuilder fact pattern previously discussed, transaction worthiness may be filtered to include only action entities applied to transactions taking place in the Midwest to prevent an action person with a high transaction worthiness value for transactions occurring in the western United States from overshadowing an action person with a lower but more geographically relevant transaction worthiness value.

### Expert Factor

An expert factor 802 is a factor calculated to represent an action person's reach and impact on subscribers as the result of that action person's expertise in a particular domain. Unlike the previously described star factor, which is a reflection of a personal connection and influence on the larger group of all transaction participants, expert factor is more closely related to an action person's reach and impact on transaction participants with regard to a specific transaction classification. Exemplary embodiments of the present invention may utilize standardized classification systems, an example of which is the North American Industry Classification System (NAICS) to classify transactions for purposes of calculating expert factor. The expert factor seeks to account for the influence that a recognized authority on a particular transaction topic or classification may have despite that authorities lesser reach than a second action person with greater reach but with lesser recognized expertise in the particular transaction topic. As was described previously in the description of star factor, transaction worthiness values may be filtered to account for the subject of the transaction, demographic characteristics of the transaction person, the geographic characteristics of the transaction, and the time sensitivity of the subject of the transaction. In certain embodiments of the invention, such filtering may also be applied to the calculation of expert factor. When calculating expert factor, examples of the invention may use the steps and formula described herein. In other embodiments of the invention, some or all of the steps and formula described herein may be used. Still other embodiments may use alternate steps, equations, inputs, and values without departing from the spirit of the invention.

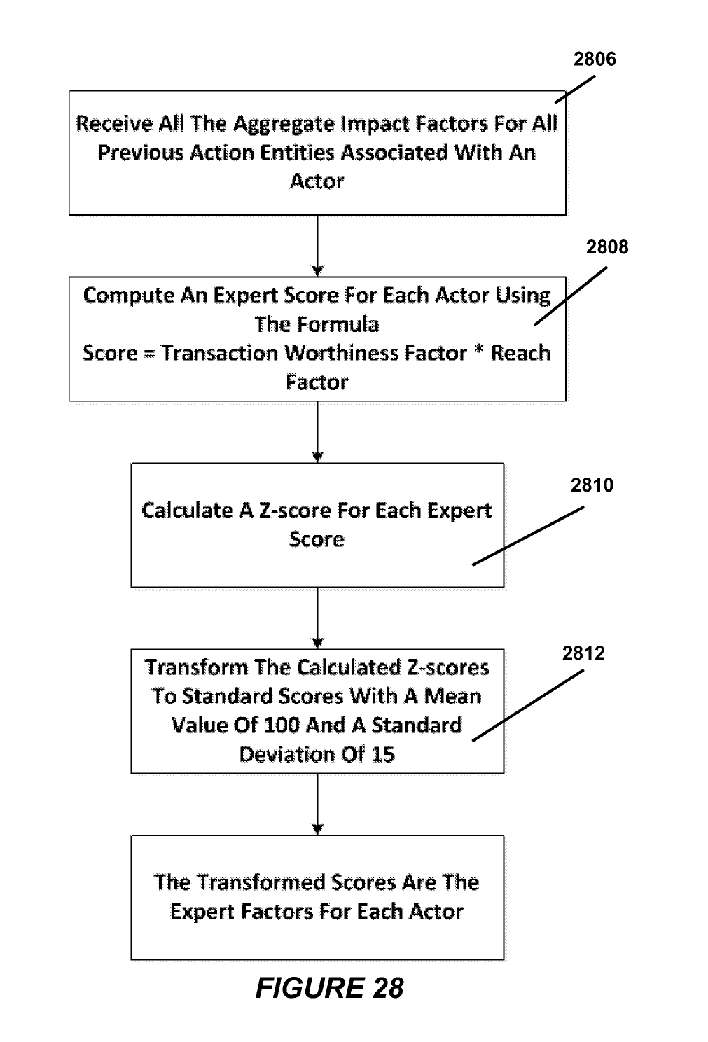

Referring to the flow chart of FIG. 28, an embodiment of the invention is illustrated in which an expert factor is calculated for a particular transaction classification. Step 2806 represents an aggregate of previous impact factors calculated for action entities associated with the action person for which the expert factor is being calculated. These previous impact factors may be used to calculate the action person's transaction worthiness value for the predetermined transaction classification as described elsewhere in this detailed description. As is illustrated at 2808, a cumulative previous action entity performance with respect to each transaction classification is computed by the processor using Equation 15. Once the cumulative previous action entity performance is computed for each action person, a z-score 2810 is computed for each computed value in the group composed of action persons for which expert factors are calculated. The resultant set of z-scores may be transformed to have a standard score with a mean of 100 and a standard deviation of 15 in step 2812. The transformed values represent expert factors for the action persons for which a score was calculated in step 2808.

Expert Score=(Action Person Transaction Worthiness of a Transaction Classification)* (reach factor) Equation 15

While certain embodiments of the disclosed systems and methods are described in detail above, the scope of the invention is not to be considered limited by such disclosure, and modifications are possible without departing from the spirit of the invention. For example, additional action entities types may become available as the result of the growth of social media applications, web sites, and methods of interacting over the Internet. In another example, additional transaction types may be considered as the result of an increase in the sales and marketing of products and services over the Internet. Another example may be the use herein of a determination of normalized values using the calculation of a z-score and normalization of the calculated z-score to standard scores having a mean value of 100 and a standard deviation of 15. One skilled in the art will realize that there are other methods of determining normalized values that may be employed without departing from the spirit of the invention.

One skilled in the art would recognize that these and other such modifications are possible without departing from the scope of the claimed invention. Thus, many of the elements indicated above may be altered or replaced by different elements which will provide the same result and fall within the spirit of the claimed invention. It is the intention, therefore, to limit the invention only as indicated by the scope of the claims.

1. A method of rating an action person's value to a party to a transaction, comprising the execution of computerized instructions to perform the steps of:
a. receiving information comprising data from a plurality of action person action entities;
b. receiving information comprising data from a plurality of transactions;
c. receiving information comprising data representing characteristics of an action person;
d. receiving information comprising data representing characteristics of a transaction person;
e. determining a transaction worthiness representing the action person's past impact on transactions, comprising the steps of:
i. determining at least one impact score representing an impact that the action person has on a transaction, using received transaction data that is previous in time to the transaction for which the action person's impact score is being determined; and
ii. determining a transaction worthiness from the determined impact scores; and
f. generating a report of the determined transaction worthiness.

2. The method of claim 1, where determination of the transaction worthiness comprises the step of summing the determined impact score(s).

3. The method of claim 1, where determining the impact score comprises the steps of:
a. determining at least one of:
i. a relevance score, representing the relevance of an action person's action entity with respect to the transaction; and
ii. an influence score, representing the action person's influence with respect to a transaction person who is a party to the transaction; and
b. determining the impact score using the at least one determined score(s).

4. The method of claim 3, where the determination of a relevance score representing the relevance of the action person's action entity with respect to the transaction person's transaction of a predefined classification comprising the steps of:
a. determining the following for each action person's action entities:
i. a content relevance score comprising at least one of:
1. a content relevance score representing the content relevance between the content of an action person's action entity and the transaction type of the transaction; and
2. a content relevance score representing the content relevance between the content of the action person's action entity and a description of the product or service which is the subject of the transaction;
ii. a context relevance score comprising at least one of:
1. a context relevance score representing the context relevance between the context of the action person's action entity and the transaction type of the transaction; and
2. a context relevance score between the context of the action person's action entity and a description of the product or service which is the subject of the transaction;
b. determining at least one of the following for each action person's action entities:
i. a time relevance score representing a time period between the time that the transaction person accesses the action person's action entity and the time that the transaction takes place; and
ii. an action type weight relevance score representing the weight that the type of action entity has on transactions of the type of the transaction: and
c. determining the relevance score using the determined score(s).

5. The method of claim 4, where determination of the relevance score comprises the step of summing the determined scores.

6. The method of claim 3, where determination of the impact score comprises the step of summing the determined score(s).

7. The method of claim 1, where determination of the relevance score comprises the steps of:
a. determining, for the action person's action entity:
i. a content relevance score representing the content relevance between the action person's action entity and the transaction; and
ii. a context relevance score representing the contextual relevance between the action person's action entity and the transaction;
b. determining, for the action person's action entity, at least one of:
i. a time relevance score representing a calculation of at least one of:
a. a time period between a time that the transaction person accesses the action person's action entity and a time that the transaction takes place; and
b. a time period between a time that the action person created the action entity and a time that the transaction takes place;
ii. an action type weight relevance score representing the relevance of the type of the action entity with regard to the type of the transaction; and
c. determining the relevance score using the determined scores for each action entity.

8. The method of claim 7, where determination of the relevance score comprises the step of summing the determined scores.

9. The method of claim 3, where determination of the influence score comprises the steps of:
a. determining at least one of:
i. a star score representing the reputation of the action person within a population of which the transaction person is a member;
ii. an expert score representing an acknowledgement of the expertise of the action person in the subject matter of the transaction; and
iii. a relationship score representing the relationship between the action person and the transaction person for that transaction; and
b. determining the influence score using the at least one determined score(s).

10. The method of claim 9, where determination of the influence score comprises the step of summing the determined score(s).

11. The method of claim 9, where determination of the relationship score comprises the steps of:
a. determining at least one of the following for the action person:
i. a collaboration score representing the collaboration between the action person and the transaction person;
ii. a connection score representing the connection between the action person and the transaction person;
iii. a friendship score representing the amount of information exchanges between the action person and the transaction person during a predetermined time period; and
iv. a transaction correlation score representing the number of action entities between the action person and the transaction person that are relevant to transactions involving either the transaction person or the action person during a predetermined time period; and
b. determining the relationship score using the at least one determined score(s).

12. The method of claim 11, where determination of the relationship score comprises the step of summing the determined score(s).

13. The method of claim 1, where the transactions used when determining the score of an action person's value to a party to a transaction are limited according to at least one of the following criteria: transaction type; demographic characteristics of the transaction person; geographic location of the transaction; and a predetermined time period during which the transaction took place.

14. A method of rating an action person's value to a party of a transaction relative to other action persons, comprising the execution of computerized instructions to perform the steps of:
a. receiving information comprising data from a plurality of action person action entities;
b. receiving information comprised of data from a plurality of transactions;
c. receiving information comprising data representing characteristics of an action person;
d. receiving information comprising data representing characteristics of the transaction persons from a plurality of transactions;
e. determining a transaction worthiness representing the action person's past impact on transactions;
f. determining a transaction worthiness for at least one additional action person representing the additional action person's past impact on transactions of which the transaction person is a participant; and
g. generating a report comprising a comparison of the transaction worthiness of the action person with the transaction worthiness of the at least one additional action person.

15. The method of claim 14, where determining the transaction worthiness comprises the steps of:
a. determining at least one impact score representing the impact that the action person has on a transaction, using received transaction data that is previous in time to the transaction for which the action person's impact score is being determined; and
b. determining the transaction worthiness using the at least one determined impact score(s).

16. The method of claim 15, where determination of the transaction worthiness comprises the step of summing the determined impact score(s).

17. The method of claim 15, where the step of determining an impact score comprises the steps of:
a. determination of at least one of:
i. a relevance score, representing the relevance of the action person's action entity with respect to the transaction; and
ii. an influence score, representing the action person's influence with respect to a transaction person for the transaction person's transaction; and
b. determining the impact score using the at least one determined score(s).

18. The method of claim 17, where determination of the impact score comprises the step of summing the determined score(s).

19. The method of claim 17, where determination of the relevance score comprises the steps of:
a. determining a content relevance score comprising at least one of:
i. a content relevance score representing the content relevance between the content of the action person's action entity and the transaction type of the transaction; and
ii. a content relevance score representing the content relevance between the content of the action person's action entity and a description of the product or service which is the subject of the transaction;
b. determining a context relevance score comprising at least one of:
i. a context relevance score representing the context relevance between the context of the action person's action entity and the transaction type of the transaction; and
ii. a context relevance score between the context of the action person's action entity and a description of the product or service which is the subject of the transaction;
iii. a time relevance score representing a calculation of at least one of:
A. a time period between a time that the transaction person accesses the action person's action entity and a time that the transaction takes place;
B. a time period between a time that an action person created an action entity and a time that the transaction takes place; and
iv. an action type weight relevance score representing the weight that the type of action entity has on transactions of the type of the transaction; and
c. determining the relevance score using the determined scores.

20. The method of claim 19, where determination of the relevance score comprises the step of summing the determined scores.

21. The method of claim 17, where determination of the influence score comprises the steps of:
a. determining at least one of:
i. a star score representing the reputation of the action person within a population of which the transaction person is a member;
ii. an expert score representing an acknowledgement of the expertise of the action person in the subject matter of the transaction; and
iii. a relationship score representing the relationship between the action person and the transaction person for that transaction; and
b. determining the influence score using the at least one determined score(s).

22. The method of claim 21, where determination of the influence score comprises the step of summing the determined score(s).

23. The method of claim 21, where determination of the relationship score of the action person who has performed action entities with respect to the transaction person comprises the steps of:
a. determining at least one of the following for the action person:
i. a collaboration score representing the amount of past collaboration between the action person and the transaction person;
ii. a connection score representing the connection between the action person and the transaction person;
iii. a friendship score representing the amount of information exchanges between the action person and the transaction person; and
iv. a transaction correlation score representing the number of action entities between the action person and the transaction person that are relevant to transactions involving either the action person or the transaction person during a predetermined period; and
b. determining the relationship score using the at least one determined score(s).

24. The method of claim 23, where determination of the relationship score comprises the step of summing the determined score(s).

25. The method of claim 14, where the transactions used when determining the score of an action person's value to a party to a transaction are limited according to at least one of the following criteria: transaction type; demographic characteristics of the transaction person; geographic location of the transaction; and a predetermined time period during which the transaction took place.

26. A method determining an expert score representing a rating of an action person's value to a party to a transaction comprising the steps of:
a. determining a subcategory of the action person's transaction worthiness of claim 1, using a predefined classification of related transactions; and
b. multiplying the subcategory of the action person's transaction worthiness by an action person's reach score representing the average number of persons who have accessed the action person's action entities during a predetermined period of time in the past.

27. The method of claim 26, where determining the action person's transaction worthiness comprises the steps of:
a. receiving information comprising data from a plurality of action person action entities;
b. receiving information comprising data from a plurality of transactions;
c. receiving information comprising data representing characteristics of an action person;
d. receiving information comprising data representing characteristics of a transaction person;
e. determining a transaction worthiness representing the action person's past impact on transactions, comprising the steps of:
i. determining at least one impact score representing an impact that the action person has on a transaction, using received transaction data that is previous in time to the transaction for which the action person's impact score is being determined; and
ii. determining a transaction worthiness from the determined impact scores.

28. The method of claim 27, where determination of the transaction worthiness comprises the step of summing the determined impact score(s).

29. The method of claim 27, where determining the impact score comprises the steps of:
a. determining at least one of:
i. a relevance score, representing the relevance of an action person's action entity with respect to the transaction; and
ii. an influence score, representing the action person's influence with respect to a transaction person who is a party to the transaction; and
b. determining the impact score using the at least one determined score(s).

30. The method of claim 29, where the determination of a relevance score representing the relevance of the action person's action entity with respect to the transaction person's transaction of a predefined classification comprising the steps of:
a. determining the following for each action person's action entities:
i. a content relevance score comprising at least one of:
1. a content relevance score representing the content relevance between the content of an action person's action entity and the transaction type of the transaction; and
2. a content relevance score representing the content relevance between the content of the action person's action entity and a description of the product or service which is the subject of the transaction;
ii. a context relevance score comprising at least one of:
1. a context relevance score representing the context relevance between the context of the action person's action entity and the transaction type of the transaction; and
2. a context relevance score between the context of the action person's action entity and a description of the product or service which is the subject of the transaction;
b. determining at least one of the following for each action person's action entities:
i. a time relevance score representing a time period between the time that the transaction person accesses the action person's action entity and the time that the transaction takes place; and
ii. an action type weight relevance score representing the weight that the type of action entity has on transactions of the type of the transaction: and
c. determining the relevance score using the determined score(s).

31. The method of claim 26, where the transactions used within the predefined transaction classification when determining the expert score of an action person are limited according to at least one of the following criteria: demographic characteristics of a transaction person associated with the transaction; geographic location of the transaction; and a predetermined time period during which the transaction took place.

32. A method of determining a star score representing a rating an action person's value to a party to a transaction comprising the steps of:
a. determining the action person's transaction worthiness of claim 1; and
b. multiplying the action person's transaction worthiness by the action person's reach score representing the average number of persons who have accessed the action person's action entities during a predetermined period of time in the past.

33. The method of claim 32, where determining the action person's transaction worthiness comprises the steps of:
f. receiving information comprising data from a plurality of action person action entities;
g. receiving information comprising data from a plurality of transactions;
h. receiving information comprising data representing characteristics of an action person;
i. receiving information comprising data representing characteristics of a transaction person;
j. determining a transaction worthiness representing the action person's past impact on transactions, comprising the steps of:
i. determining at least one impact score representing an impact that the action person has on a transaction, using received transaction data that is previous in time to the transaction for which the action person's impact score is being determined; and
ii. determining a transaction worthiness from the determined impact scores.

34. The method of claim 33, where determination of the transaction worthiness comprises the step of summing the determined impact score(s).

35. The method of claim 33, where determining the impact score comprises the steps of:
c. determining at least one of:
iii. a relevance score, representing the relevance of an action person's action entity with respect to the transaction; and
iv. an influence score, representing the action person's influence with respect to a transaction person who is a party to the transaction; and
d. determining the impact score using the at least one determined score(s).

36. The method of claim 35, where the determination of a relevance score representing the relevance of the action person's action entity with respect to the transaction person's transaction of a predefined classification comprising the steps of:
b. determining the following for each action person's action entities:
i. a content relevance score comprising at least one of:
1. a content relevance score representing the content relevance between the content of an action person's action entity and the transaction type of the transaction; and
2. a content relevance score representing the content relevance between the content of the action person's action entity and a description of the product or service which is the subject of the transaction;
ii. a context relevance score comprising at least one of:
1. a context relevance score representing the context relevance between the context of the action person's action entity and the transaction type of the transaction; and
2. a context relevance score between the context of the action person's action entity and a description of the product or service which is the subject of the transaction;
b. determining at least one of the following for each action person's action entities:
i. a time relevance score representing a time period between the time that the transaction person accesses the action person's action entity and the time that the transaction takes place; and
ii. an action type weight relevance score representing the weight that the type of action entity has on transactions of the type of the transaction: and
c. determining the relevance score using the determined score(s).

37. The method of claim 32, where the transactions used when determining the rating of an action person's value to a party to a transaction are additionally limited according to at least one of the following criteria: demographic characteristics of a transaction person associated with the transaction; geographic location of the transaction; and a predetermined time period during which the transaction took place.

38. A method of determining a reach score representing an action person's contact with others comprising the steps of:
a. receiving data representing a count of how many persons have accessed the action person's action entities during a predetermined period of time in the past; and
b. calculating an average count of persons accessing the action person's action entities during a predetermined period of time.

39. The method of claim 38, where the transaction persons used when determining the reach score of an action person are limited according to at least one of the following criteria: demographic characteristics of persons accessing the action person's action entities; geographic location of a transaction with which the transaction person is associated; and a predetermined time period during which the transaction took place.
